(19) United States
(12) Patent Application Publication
(10) Pub. No.: US 2002/0021826 A1
(43) Pub. Date: Feb. 21, 2002

(54) Image signal processing apparatus and method thereof

(76) Inventor: Hiroshi Okuda, Tokyo (JP)

Correspondence Address: FROMMER LAWRENCE & HAUG LLP, 745 FIFTH AVENUE, NEW YORK, NY, 10151, US

(21) Appl. No.: 09/928,554

(22) Filed: Aug. 13, 2001

(30) Foreign Application Priority Data
Aug. 14, 2000 (JP) P2000-245926

(51) Int. Cl. G06K 9/00; G06K 9/54; G06K 9/60

(52) U.S. Cl. 382/107; 382/304

(57) ABSTRACT

An image signal processing apparatus and a method thereof capable of preventing erroneous detection and performing IP conversion at a high accuracy, comprising deciding a function for expressing a moving quantity by an absolute value of a difference of two data, finding a larger value of a moving quantity of data of a pixel A in the present field at the same position as a pixel R whose motion is to be detected and data of a pixel D at the same position after a two-field delay, a moving quantity of data of a pixel B after a one-field delay one line above the pixel R and data of a pixel E at the same position after a three-field delay, and a moving quantity of data of a pixel C after a one-field delay one line below the pixel R and data of a pixel F at the same position after a three-field delay and a larger value of a moving quantity of data obtained by intra-field interpolation from pixels B and C and data of the pixel D and a moving quantity of the data of the pixel A and D, and using the smaller one of the two larger values as the moving quantity of the pixel R.

### BACKGROUND OF THE INVENTION

1. Field of the Invention

The present invention relates to an image processing apparatus, more particularly an image processing apparatus for converting an interlace signal to a progressive signal (IP conversion) and a method thereof.

2. Description of the Related Art

Many image signals in the world, such as television or video signals, are interlaced.

Contrary to this, computer signals are progressive. For example, in order to simultaneously display a computer image and a television image on the same computer display, the interlace signal must be converted to a progressive signal.

Further, with an interlace signal, due to its characteristic, flicker occurs if there is a fine horizontal line in the image, but such flicker does not occur with a progressive signal and the image is displayed clean. Therefore, recently, there are also TV receivers for the home which internally convert signals from interlace to progressive signals and display images by progressive signals.

### REGARDING IP CONVERSION

In an interlace signal, as shown in FIG. 32, one frame is comprised by two fields having line data shifted from each other at every other line.

Contrary to this, in a progressive signal, as shown in FIG. 33, all line data is present (filled) from the start.

When converting an interlace signal to a progressive signal, since the interlace signal only has data every other line, interpolation data is formed and output for the lines not having data.

There are a variety of methods for forming this interpolation data, but in general, as shown in FIG. 34, ordinarily use is made of a method in which motion is detected, the data is divided to a moving area and a still area, the interpolation data is prepared from the data inside the field for the moving area, and the data of the same line of the previous field is used as it is for the still area.

Further, conventionally, in the process of motion detection when performing IP conversion, decision is made by comparing the data of the present field and the two-field delayed data.

However, in the method of the related art described above, for example, in an image where there is an object moving at a high speed in a background frozen at the original image on which IP conversion is to be performed, the actually moving area was erroneously detected as being “still”.

In addition, for example, as shown in FIG. 35, when white and black streaks are scrolled and coincidentally viewing the same pixel position, in each field, if white, black, white, black continues, even though something is actually moving, it was erroneously detected as being “still” in the method of the related art.

Further, in the method of the related art, in order to keep the erroneous detection from standing out, sometimes processing is introduced to expand the area judged to be “moving”, but due to this, an area that was actually still was sometimes judged to be “moving”.

### SUMMARY OF THE INVENTION

An object of the present invention is to provide an image signal processing apparatus and a method thereof capable of preventing erroneous detection and performing IP conversion at a high accuracy without the necessity of expanding a moving area in order to perform motion detection correctly in units of pixel.

In order to achieve the object, according to a first aspect of the present invention, there is provided an image signal processing apparatus for forming interpolation data for lines without interlace signal data by detecting motion and for converting image data from an interlace signal to a progressive signal based on the interpolation data, comprising a processing means for detecting motion at the time of conversion of image data from an interlace signal to a progressive signal by using data of a present field, one-field delayed data, two-field delayed data, and three-field delayed data, deciding a function for expressing a moving quantity by an absolute value of a difference of two of the data, finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay, and using the smaller one of the two maximum values found as the moving quantity of the pixel R whose motion is to be detected.

Preferably, the processing means uses the data obtained by intra-field interpolation from pixels B and C at lines above and below the pixel R whose motion is to be detected for a place of a large moving quantity and uses the data of the pixel D at the same position after a two-field delay for a place of a small moving quantity.

Alternatively, the processing means uses the data obtained by intra-field interpolation from pixels B and C at lines above and below the pixel R whose motion is to be detected for a place of a large moving quantity, while uses an average of the data of the pixel A at the same position in the present field and the data of the pixel D at the same position after a two-field delay for a place of a small moving quantity.

In addition, in order to achieve the above object, according to a second aspect of the present invention, there is provided an image signal processing apparatus for forming interpolation data for lines without interlace signal data by detecting motion and converting image data from an interlace signal to a progressive signal based on the interpolation data, comprising a processing means for detecting motion at the time of conversion of image data from an interlace signal to a progressive signal by using data of a present field, one-field delayed data, two-field delayed data, and three-field delayed data, deciding a function for expressing a moving quantity by an absolute value of a difference of two of the data, finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel A at the same position in the present field and a moving quantity of data of the pixel A in the present field at the same position as the pixel R whose motion is to be detected and data of the pixel D at the same position after a two-field delay, and using the smaller one of the two maximum values as the moving quantity of the pixel R whose motion is to be detected.

Preferably, the processing means uses the data obtained by intra-field interpolation from pixels B and C at lines above and below the pixel R whose motion is to be detected for a place of a large moving quantity, while uses the data of the pixel A at the same position in the present field for a place of a small moving quantity.

Alternatively, the processing means uses the data obtained by intra-field interpolation from pixels B and C at lines above and below the pixel R whose motion is to be detected for a place of a large moving quantity, while uses an average of the data of the pixel A at the same position in the present field and the data of the pixel D at the same position after a two-field delay for a place of a small moving quantity.

Alternatively, when finding intra-field interpolation data, the processing means interpolates by using the average value of the data at immediately upper and lower positions in lines above and below if the absolute value of the difference of the data at immediately upper and lower positions in lines above and below is less than a certain threshold value, while interpolates by using the average value of the data of two central values among a plurality of pixels in the vicinity of the lines above and below in other cases.

According to the third aspect of the present invention, there is provided an image signal processing apparatus for forming interpolation data for lines without interlace signal data by detecting motion and for converting image data from an interlace signal to a progressive signal based on the interpolation data, comprising a first memory for writing and reading of moving quantity obtained by calculation and a processing means for detecting motion at the time of conversion of image data from an interlace signal to a progressive signal by using data of a present field and two-field delayed data, deciding a function for expressing a moving quantity by an absolute value of a difference of two data, finding a moving quantity of data of a pixel A in the present field at the same position as a pixel R whose motion is to be detected and data of a pixel D at the same position after a two-field delay, writing this value into the first memory, reading out from the first memory a moving quantity of data of a pixel B after a one-field delay one line above a pixel R whose motion is to be detected of one field before and data of a pixel E at the same position after a three-field delay and a moving quantity of data of a pixel C after a one-field delay one line below the pixel R whose motion is to be detected and data of a pixel F at the same position after a three-field delay, and using these moving quantities to detect motion.

Preferably, the processing means finds a first moving quantity of the data of the pixel A in the present field at the same position as the pixel R whose motion is to be detected and the data of the pixel D at the same position after a two-field delay, writes this moving quantity into the first memory, reads out from the first memory a second moving quantity of the data of the pixel B after a one-field delay one line above the pixel R whose motion is to be detected of one field before and the data of the pixel E at the same position after a three-field delay, and a third moving quantity of the data of the pixel C after a one-field delay one line below the pixel R whose motion is to be detected and the data of the pixel F at the same position after a three-field delay, finds a fourth moving quantity that is the maximum value of the first moving quantity and the second moving quantity and a fifth moving quantity that is the maximum value of the first moving quantity and the third moving quantity, uses the smaller value of the fourth moving quantity and fifth moving quantity as the moving quantity of the pixel, uses the data obtained by intra-field interpolation from pixels B and C at lines above and below the pixel R whose motion is to be detected for a place of a maximum moving quantity, and uses the data of the pixel D at the same position after a two-field delay for a place of a small moving quantity.

Alternatively, the present invention further comprises a second memory for storing a predetermined screen's worth of values, and the processing means finds a first moving quantity of the data of the pixel A in the present field at the same position as the pixel R whose motion is to be detected and the data of the pixel D at the same position after a two-field delay, writes this moving quantity into the first memory, reads out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay, finds a fourth moving quantity that is the maximum value of the first moving quantity and second moving quantity and a fifth moving quantity that is the maximum value of the first moving quantity and third moving quantity, finds a sixth moving quantity that is the smaller value of the fourth moving quantity and fifth moving quantity, finds an eighth moving quantity that is the larger value of a seventh moving quantity of data obtained by intra-field interpolation from pixels B and C at lines above and below the pixel R whose motion is to be detected and the data of the pixel D at the same position after a two-field delay and first moving quantity of the data of the pixel A in the present field at the same position as the pixel R whose motion is to be detected and the data of the pixel D at the same position after a two-field delay, writes a specific initial value to the second memory if the sixth moving quantity is greater than a certain threshold value, otherwise reduces the data read from the second memory by 1, writes zero to the second memory if the result is less than 0, uses the sixth moving quantity as the result of motion detection if the value is zero, otherwise uses the eighth moving quantity as the result of motion detection, uses the data obtained by intra-field interpolation from pixels B and C at lines above and below the pixel R whose motion is to be detected for a place of a large moving quantity, and uses the data of the pixel D at the same position after a two-field delay for a place of a small moving quantity.

More preferably, the processing means uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

Alternatively, the processing means comprises a single instruction stream multiple data stream (SIMD) control processor including processor elements arranged in parallel one dimensionally.

More preferably, the SIMD control processor including processor elements arranged in parallel one dimensionally is a processor for bit processing.

Alternatively, the processing means includes a plurality of logic circuits.

In addition, in order to achieve the above object, according to a fourth aspect of the present invention, there is provided an image signal processing method for forming interpolation data for lines without interlace signal data by detecting motion and for converting image data from an interlace signal to a progressive signal based on the interpolation data, comprising, a step of detecting motion at the time of conversion image data from an interlace signal to a progressive signal, comprising the steps of using data of a present field, one-field delayed data, two-field delayed data, and three-field delayed data, deciding a function for expressing a moving quantity by an absolute value of a difference of two of the data, finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay, and using the smaller one of the two maximum values as the moving quantity of the pixel R whose motion is to be detected.

Preferably, the method uses the data obtained by intra-field interpolation from pixels B and C at lines above and below the pixel R whose motion is to be detected for a place of a large moving quantity and uses the data of the pixel D at the same position after a two-field delay for a place of a small moving quantity.

Alternatively, the method uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

In addition, in order to achieve the above object, according to a fifth aspect of the present invention, there is provided an image signal processing method for forming interpolation data for lines without interlace signal data by detecting motion and for converting image data from an interlace signal to a progressive signal based on the interpolation data, comprising, a step of detecting motion at the time of conversion image data from an interlace signal to a progressive signal, comprising the steps of using data of a present field, one-field delayed data, two-field delayed data, and three-field delayed data, deciding a function for expressing a moving quantity by an absolute value of a difference of two of the data, finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel A at the same position in the present field and a moving quantity of data of the pixel A in the present field at the same position as the pixel R whose motion is to be detected and data of the pixel D at the same position after a two-field delay, and using the smaller one of the two maximum values as the moving quantity of the pixel R whose motion is to be detected.

Preferably, the method uses the data obtained by intra-field interpolation from pixels B and C at lines above and below the pixel R whose motion is to be detected for a place of a large moving quantity and uses the data of the pixel A at the same position in the present field for a place of a small moving quantity.

Alternatively, the method uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

In addition, in order to achieve the above object, according to a sixth aspect of the present invention, there is provided an image signal processing method for forming interpolation data for lines without interlace signal data by detecting motion and for converting image data from an interlace signal to a progressive signal based on the interpolation data, comprising, a step of detecting motion at the time of conversion image data from an interlace signal to a progressive signal, comprising the steps of using data of a present field and two-field delayed data, deciding a function for expressing a moving quantity by an absolute value of a difference of the two data, finding a moving quantity of data of a pixel A in the present field at the same position as a pixel R whose motion is to be detected and data of a pixel D at the same position after a two-field delay, writing this value into a first memory, reading out from the first memory a moving quantity of data of a pixel B after a one-field delay one line above a pixel R whose motion is to be detected of one field before and data of a pixel E at the same position after a three-field delay and a moving quantity of data of a pixel C after a one-field delay one line below the pixel R whose motion is to be detected and data of a pixel F at the same position after a three-field delay, and using these moving quantities to detect motion.

Preferably, the method comprises the steps of finding a first moving quantity of the data of the pixel A in the present field at the same position as the pixel R whose motion is to be detected and the data of the pixel D at the same position after a two-field delay, writing this moving quantity into the first memory, reading out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay, finding a fourth moving quantity that is the maximum value of the first moving quantity and the second moving quantity and a fifth moving quantity that is the maximum value of the first moving quantity and the third moving quantity, using the smaller value of the fourth moving quantity and fifth moving quantity as the moving quantity of the pixel, using the data obtained by intra-field interpolation from pixels B and C at lines above and below the pixel R whose motion is to be detected for a place of a large moving quantity, and using the data of the pixel D at the same position after a two-field delay for a place of a small moving quantity.

Alternatively, the method comprises the steps of finding a first moving quantity of the data of the pixel A in the present field at the same position as the pixel R whose motion is to be detected and the data of the pixel D at the same position after a two-field delay, writing this moving quantity into the first memory, reading out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay, finding a fourth moving quantity that is the maximum value of the first moving quantity and second moving quantity and a fifth moving quantity that is the maximum value of the first moving quantity and third moving quantity, finding a sixth moving quantity that is the smaller value of the fourth moving quantity and fifth moving quantity, finding an eighth moving quantity that is the larger value of a seventh moving quantity of data obtained by intra-field interpolation from pixels B and C at lines above and below the pixel R whose motion is to be detected and the data of the pixel D at the same position after a two-field delay and first moving quantity of the data of the pixel A in the present field at the same position as the pixel R whose motion is to be detected and the data of the pixel D at the same position after a two-field delay, writing a specific initial value to a second memory for storing a predetermined screen's worth of values if the sixth moving quantity is greater than a certain threshold value, otherwise reducing the data read from the second memory by 1, writing zero to the second memory if the result is less than 0, using the sixth moving quantity as the result of motion detection if the value is zero, otherwise using the eighth moving quantity as the result of motion detection, using the data obtained by intra-field interpolation from pixels B and C at lines above and below the pixel R whose motion is to be detected for a place of a large moving quantity, and using the data of the pixel D at the same position after a two-field delay for a place of a small moving quantity.

More preferably, the method uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

Still more preferably, when finding intra-field interpolation data, if the absolute value of the difference of the data at immediately upper and lower positions in lines above and below is less than a certain threshold value, the method interpolates by using the average value of the data at immediately upper and lower positions in lines above and below, otherwise, interpolates by using the average value of the data of two central values among a plurality of pixels in the vicinity of the lines above and below.

That is, according to the present invention, for example, when the processing means detects motion at the time of conversion image data from an interlace signal to a progressive signal, the processing means uses data of a present field, one-field delayed data, two-field delayed data, and three-field delayed data and decides a function for expressing a moving quantity by an absolute value of a difference of two data.

Then, the processing means finds a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay.

Further, the processing means finds a larger value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay.

Further, the smaller one of the two larger values is used as the moving quantity of the pixel R whose motion is to be detected.

### BRIEF DESCRIPTION OF THE DRAWINGS

These and other objects and features of the present invention will become clearer from the following description of the preferred embodiments given with reference to the attached drawings, in which:

FIG. 1 is a block diagram of a first embodiment of an image signal processing apparatus according to the present invention;

FIG. 2 is a view for explaining motion detection during IP conversion by a digital signal processor (DSP) serving as a processing means according to the present invention;

FIG. 3 is a block diagram of the fundamental configuration of an SIMD control processor constituting a DSP according to the present invention;

FIGS. 4A to 4E are time charts for explaining the basic operation of an image DSP according to the first embodiment;

FIG. 5 is a view for explaining the concrete processing in IP conversion according to the first embodiment;

FIG. 6 is a view for explaining a function for determining moving quantity in IP conversion according to the first embodiment;

FIG. 7 is a view for explaining intra-field interpolation in IP conversion according to the first embodiment;

FIG. 8 is a first flow chart for explaining the concrete processing in IP conversion according to the first embodiment;

FIG. 9 is a second flow chart for explaining the concrete processing in IP conversion according to the first embodiment;

FIG. 10 is a third flow chart for explaining the concrete processing in IP conversion according to the first embodiment;

FIG. 11 is a fourth flow chart for explaining the concrete processing in IP conversion according to the first embodiment;

FIG. 12 is a fifth flow chart for explaining the concrete processing in IP conversion according to the first embodiment;

FIG. 13 is a sixth flow chart for explaining the concrete processing in IP conversion according to the first embodiment;

FIG. 14 is a seventh flow chart for explaining the concrete processing in IP conversion according to the first embodiment;

FIG. 15 is an eighth flow chart for explaining the concrete processing in IP conversion according to the first embodiment;

FIG. 16 is a block diagram of a second embodiment of an image signal processing apparatus according to the present invention;

FIG. 17 is a view f or explaining motion detection during IP conversion by a DSP serving as a processing means according to the second embodiment of the present invention;

FIGS. 18A to 18E are time charts for explaining the basic operation of an image DSP according to the second embodiment;

FIG. 19 is a view for explaining the concrete processing in IP conversion according to the second embodiment;

FIG. 20 is a view for explaining a function for determining moving quantity in IP conversion according to the second embodiment;

FIG. 21 is a view for explaining intra-field interpolation in IP conversion according to the second embodiment;

FIG. 22 is a first flow chart for explaining the concrete processing in IP conversion according to the second embodiment;

FIG. 23 is a second flow chart for explaining the concrete processing in IP conversion according to the second embodiment;

FIG. 24 is a third flow chart for explaining the concrete processing in IP conversion according to the second embodiment;

FIG. 25 is a fourth flow chart for explaining the concrete processing in IP conversion according to the second embodiment;

FIG. 26 is a fifth flow chart for explaining the concrete processing in IP conversion according to the second embodiment;

FIG. 27 is a sixth flow chart for explaining the concrete processing in IP conversion according to the second embodiment;

FIG. 28 is a seventh flow chart for explaining the concrete processing in IP conversion according to the second embodiment;

FIG. 29 is a block diagram of an example of the configuration of a processing means combining logic circuits according to the present invention;

FIG. 30 is a view for explaining functions of parts in the circuit of FIG. 29;

FIG. 31 is a view for explaining functions of blocks for intra-field interpolation as shown in FIG. 29;

FIG. 32 is a view for explaining an interlace signal;

FIG. 33 is a view for explaining a progressive signal;

FIG. 34 is a view for explaining IP conversion; and

FIG. 35 is a view for explaining problems of the related art.

### DESCRIPTION OF THE PREFERRED EMBODIMENTS

Below, preferred embodiments of the present invention will be explained with reference to the accompanying figures.

First Embodiment

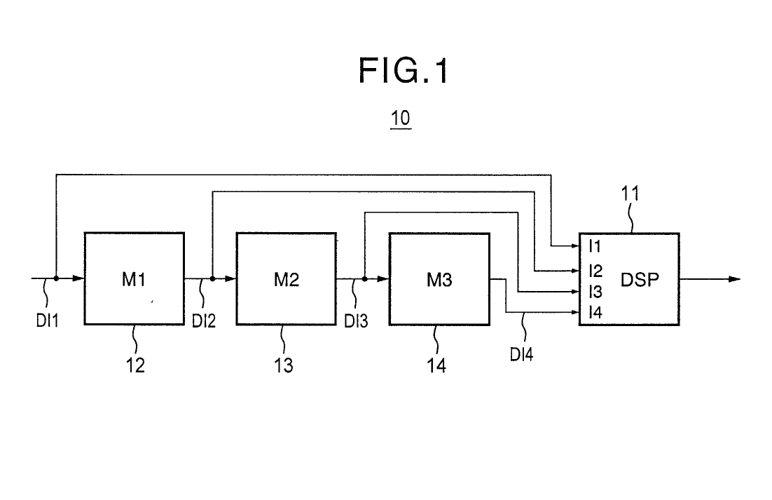

FIG. 1 is a block diagram of a first embodiment of an image signal processing apparatus according to the present invention.

The image signal processing apparatus 10, as shown in FIG. 1, comprises a DSP 11 serving as a processing means and memories 12, 13, and 14 for generating one-field delay as main constitutional elements.

The memories 12 (M1), 13 (M2), and 14 (M3) for generating one field's worth of delay are arranged at the input stage of the image data of the DSP 11.

An input line of the image data is connected to an input terminal of the memory 12 and a first input terminal (I1) of the DSP 11.

An output terminal of the memory 12 is connected to the input terminal of the memory 13 and a second input terminal (I2) of the DSP 11.

An output terminal of the memory 13 is connected to the input terminal of the memory 14 and a third input terminal (I3) of the DSP 11.

An output terminal of the memory 14 is connected to a fourth input terminal (I4) of the DSP 11.

The DSP 11 stores data DI1 to the input terminal I1 and data DI3 to the input terminal I3 in its internal memory.

Further, the DSP 11 stores two line's worth of data DI2 to the input terminal I2 and data DI4 to the input terminal I4 in its internal memory.

The DSP 11 performs IP conversion of an image signal of an image source from an interlace signal to a progressive signal based on parameters provided by a not illustrated control system.

At time of the conversion of image data from an interlace signal to a progressive signal, the DSP 11 performs motion detection as first motion detection processing in the following way.

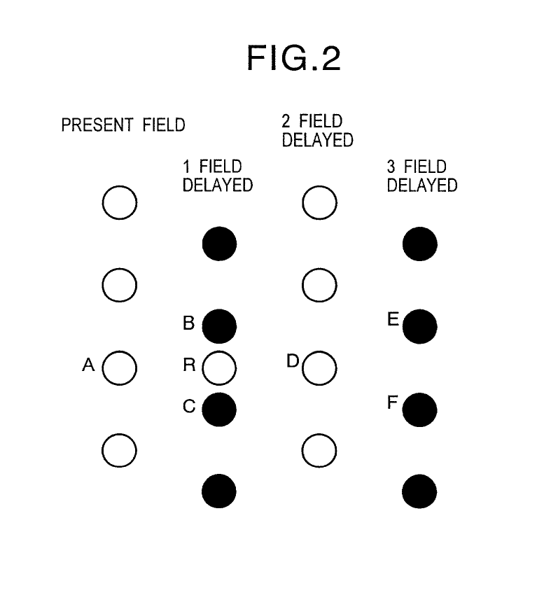

That is, the DSP 11 uses data of a present field, one-field delayed data, two-field delayed data, and three-field delayed data and decides a function for expressing a moving quantity by an absolute value of a difference of two of the data. As shown in FIG. 2, the DSP 11 finds a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position as the pixel B after a three-field delay, and a moving quantity of data of a pixel C after a one-field delay one line below the pixel R whose motion is to be detected and data of a pixel F at the same position as the pixel C after a three-field delay. Further, the DSP 11 finds a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay. Further, the DSP 11 uses the smaller one of the two larger values as the moving quantity of the pixel R whose motion is to be detected.

Further, the DSP 11 uses the data obtained by intra-field interpolation from pixels B and C at lines above and below the pixel R whose motion is to be detected for a place of large moving quantity and uses the data of the pixel D at the same position after a two-field delay for a place of small moving quantity.

Further, at the time of conversion of image data from an interlace signal to a progressive signal, the DSP 11 performs motion detection as second motion detection processing in the following way.

That is, the DSP 11 uses data of a present field, one-field delayed data, two-field delayed data, and three-field delayed data and decides a function for expressing a moving quantity by an absolute value of a difference of two of the data. The DSP 11 finds a larger value of a moving quantity of data of the pixel A in the present field at the same position as the pixel R whose motion is to be detected and data of the pixel D at the same position as the pixel A after a two-field delay, a moving quantity of data of the pixel B after a one-field delay one line above the pixel R whose motion is to be detected and data of the pixel E at the same position as the pixel B after a three-field delay, and a moving quantity of data of a pixel C after a one-field delay one line below the pixel R whose motion is to be detected and data of a pixel F at the same position as the pixel C after a three-field delay. The DSP 11 also finds a larger value of a moving quantity of data obtained by intra-field interpolation from pixels B and C at lines above and below the pixel R whose motion is to be detected and data of the pixel A at the same position in the present field and a moving quantity of data of the pixel A in the present field at the same position as the pixel R whose motion is to be detected and data of the pixel D at the same position as the pixel A after a two-field delay. Further, the DSP 11 uses the smaller one of the two larger values as the moving quantity of the pixel R whose motion is to be detected.

Further, the DSP 11 uses the data obtained by intra-field interpolation from pixels B and C at lines above and below the pixel R whose motion is to be detected for a place of large moving quantity and uses the data of the pixel A at the same position in the present field for a place of small moving quantity.

Further, in the first and second motion detection processing, the DSP 11 uses the data obtained by intra-field interpolation from pixels B and C at lines above and below the pixel R whose motion is to be detected for a place of large moving quantity and uses an average of the data of the pixel A at the same position in the present field and the data of the pixel D at the same position after a two-field delay for a place of small moving quantity.

Furthermore, when determining intra-field interpolation data, if the absolute value of the difference of the data at immediately upper and lower positions in lines above and below is less than a certain threshold value, the DSP 11 interpolates by using the average value of the data at immediately upper and lower positions in lines above and below, otherwise, the DSP 11 interpolates by using the average value of the data of two central values among a number of pixels in the vicinity of the lines above and below (six pixels nearby in the present invention).

The DSP 11 is a linear array type DSP, for example, is a parallel processor of the sing instruction stream multiple data stream (SIMD) control type comprised of a large number of processor elements arranged in parallel one dimensionally.

Below, an explanation will be made of the concrete configuration of an SIMD control processor and the concrete processing of the IP conversion in the DSP 11 in order with reference to the drawings.

### Fundamental Configuration of SIMD Control Processor

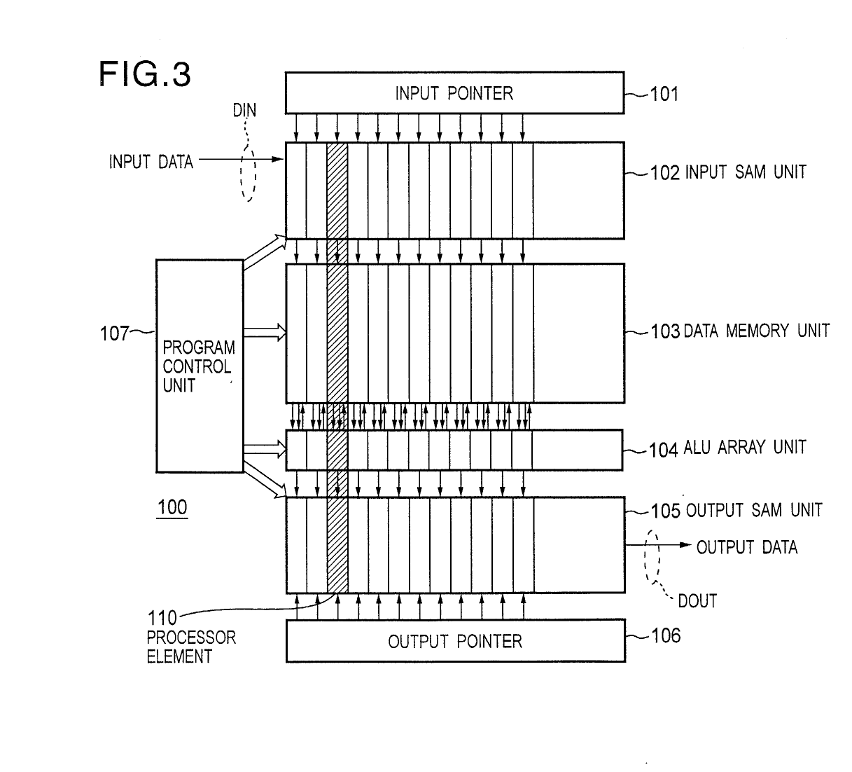

Below, an explanation will be made of the configuration of a SIMD control processor with reference to FIG. 3.

This SIMD control processor 100 is configured by, as shown in FIG. 3, an input pointer (input skip register) 101, an input serial access memory (SAM) unit (input register) 102, a data memory unit (local memory) 103, an arithmetic and logic unit (ALU) array unit 104, an output SAM unit (output register) 105, an output pointer (output skip register) 106, and a program control unit 107.

Among these components, the input SAM unit 102, data memory unit 103, and output SAM unit 105 are mainly configured by memories.

The input SAM unit 102, data memory unit 103, ALU array unit 104, and output SAM unit 105 form a plurality of (at least the number H of pixels during one horizontal scanning period of the original image) processor elements 110 arranged in parallel in the form of a linear array.

Each of the processor elements 110 (single element) has the components of an independent processor and corresponds to the part indicated by hatching in FIG. 3. Further, a plurality of processor elements 110 are arranged in parallel in the horizontal direction in FIG. 3 to configure a group of processor elements.

The input pointer (input skip register) 101 is a 1-bit shift register, shifts a 1-bit signal [input pointer signal (SIP)] of a logic value 1 (H) whenever the one pixel's worth of pixel data of the original image is input from an external image processing apparatus (not illustrated) or the like to thereby designate a processor element 110 in charge of the one pixel's worth of input pixel data and writes the corresponding pixel data of the original image into the input SAM unit 102 (input SAM cell) of the designated processor element 110.

That is, the input pointer 101 writes the first pixel data of the original image input according to a clock signal synchronous to the pixel data into the input SAM unit 102 of the processor element 110 at the left end of the SIMD control processor 100 shown in FIG. 3 for every horizontal scanning period of the original image by setting the input pointer signal with respect to the processor element 110 at the left end of FIG. 3 at the logic value 1 first. Further, whenever the clock signal changes by one cycle, the input pointer signal of the logic value 1 for the right adjacent processor element 110 is sequentially shifted rightward, whereby the image data of the original image is written into the input SAM unit 102 of each of the processor elements 110 pixel by pixel.

The input SAM unit (input register) 102 stores the one pixel's worth of pixel data (input data) input from the external image processing apparatus to an input terminal DIN when the input pointer signal input from the input pointer 101 becomes the logic value 1 as mentioned above. That is, the input SAM unit 102 of the processor element 110 stores one horizontal scanning period of the original image worth of the pixel data for every horizontal scanning period as a whole.

Further, the input SAM unit 102 transfers the stored one horizontal scanning period of the original image worth of pixel data (input data) to the data memory unit 103 according to need in the next horizontal scanning period under the control of the program control unit 107.

The data memory unit (local memory) 103 stores the pixel data of the original image input from the input SAM unit 102, the data in the middle of processing, constant data, etc. according to the logic value of the input pointer signal (SIP) input from the input pointer 101 under the control of the program control unit 107 and outputs the same to the ALU array unit 104.

The ALU array unit 104 performs arithmetic operations and logical operations on the pixel data of the original image input from the data memory unit 103, the data in the middle of processing, constant data, etc. under the control of the program control unit 107 and stores the same at predetermined addresses of the data memory unit 103.

Note that, the ALU array unit 104 performs all of the operations with respect to the pixel data of the original image in units of bits and performs the operations on one bit' worth of data for every cycle.

The output SAM unit (input register) 105 receives the transfer of the result of the processing from the data memory unit 103 when the processing allocated to one horizontal scanning period is ended and stores the same under the control of the program control unit 107.

Further, the output SAM unit 105 outputs the stored data to the outside according to an output pointer signal (SOP) input from the output pointer 106.

The output pointer (output slip register) 106 is configured by a 1-bit shift register, selectively activates the output pointer signal (SOP) with respect to the output SAM unit 105, and controls the output of the processing result (output data).

The program control unit 107 is configured by a program memory, a sequence control circuit for controlling the advance of the program stored in the program memory, a “ROW” address decoder for memories configuring the input SAM unit 102, the data memory unit 103, the output SAM unit 105 (all not illustrated), and so on.

The program control unit 107 stores a single program by these components, generates various control signals based on the stored single program for every horizontal scanning period of the original image, and controls all processor elements 110 via the generated various control signals in cooperation to thereby perform the processing with respect to the image data. Control of a plurality of processor elements based on a single program in this way will be referred to as SIMD control.

Each processor element 110 is a 1-bit processor and performs a logical operation and arithmetic operation with respect to each of the pixel data of the original image input from an external image processing apparatus or a previous circuit. The processor elements 110 as a whole realize filtering etc. in the horizontal direction and vertical direction by a FIR digital filter.

Note that, the SIMD control by the program control unit 107 is carried out with the horizontal scanning period as a cycle, therefore each processor element 110 can execute the program of a number of steps obtained by dividing the horizontal scanning period by the cycle of the command of the processor element 110 at the larger value for every horizontal scanning period.

Further, each processor element 110 is connected to the adjoining processor elements 110 and has a function of inter-processor communication with the adjoining processor elements 110 according to need.

That is, each processor element 110 can perform processing by accessing for example the data memory unit 103 of the right adjacent or left adjacent processor element 110 under the SIMD control of the program control unit 107. Further, by repeated access to the right adjacent processor elements 110, a processor element 110 can access the data memory unit 103 of a not directly connected processor element 110 and read out the data. The processor elements 110 realize the filtering in the horizontal direction as a whole by utilizing the communication function between adjoining processors.

Here, for example, if inter-processor communication is carried out when processing between pixel data separated from each other in the horizontal direction by about 10 pixels become necessary, the number of program steps becomes very large, but actual FIR filtering includes almost no processing between pixel data separated from each other by as much as 10 pixels. Most of the processing is with respect to successive pixel data. Accordingly, there is almost no possibility of the number of program steps of the FIR filtering for the inter-processor communication increasing and inefficiency resulting.

Further, each processor element 110 always exclusively is in charge of processing of pixel data at the same position in the horizontal scanning direction. Accordingly, the write address of the destination data memory unit 103 to which the pixel data (input data) of the original image is transferred from the input SAM unit 102 is changed for every initialization of the horizontal scanning period. The input data of the past horizontal scanning periods can be held, so the processor elements 110 can filter the pixel data of the original image also in the vertical direction.

Note that, the input processing (first processing) for writing the pixel data (input data) of the original image in each of the processor elements 110 to the input SAM unit 102, the transfer processing of the input data stored in the input SAM unit 102 to the data memory unit 103 under the control of the program control unit 107, the operations processing by the ALU array unit 104, the transfer processing of the processing result (output data) to the output SAM unit 105 (second processing), and the output processing (third processing) of the output data from the output SAM unit 105 are executed in a pipeline format while defining one horizontal scanning period as the processing cycle.

Accordingly, when noting the input data, each of the first to third processings with respect to the identical input data requires one horizontal scanning period's worth of processing time, therefore it is considered that three horizontal scanning periods' worth of processing time is required from the start to the end of these three processings. However, these three processings are executed in parallel in a pipeline format, therefore, on the average, only one horizontal scanning period's worth of processing time is required for processing one horizontal scanning period' worth of the input data.

Below, an explanation will be made of the basic operation of the linear array type SIMD control processor for the image processing shown in FIG. 3.

The input pointer 101 sequentially shifts the input pointer signal of a logic value 1 (H) with respect to each processor element 110 in the initial horizontal scanning period (first horizontal scanning period) according to a clock synchronous to the input pixel data of the original image so as to designate the processor element 110 performing processing for each pixel data of the original image.

The pixel data of the original image is input to the input SAM unit 102 via the input terminal DIN.

The input SAM unit 102 stores the one pixel of the original image worth of pixel data in each processor element 110 according to the logic value of the input pointer signal.

All input SAM units 102 of the processor elements 110 corresponding to the pixels contained in one horizontal scanning period store the pixel data of the original image. Then, when one horizontal scanning period's worth of the pixel data is stored as a whole, the input processing (first processing) is ended.

When the input processing (first processing) is ended, the input SAM unit 102, data memory unit 103, ALU array unit 104, and output SAM unit 105 of each processor element 110 are SIMD controlled by the program control unit 107 and the processing with respect to the pixel data of the original image is executed for every horizontal scanning period according to a single program.

Namely, each input SAM unit 102 transfers each pixel data (input data) of the original image stored in the first horizontal scanning period to the data memory unit 103 in the next horizontal scanning blanking period (second horizontal scanning period).

Note that, this data transfer is realized by controlling the input SAM unit 102 and the data memory unit 103 so that the program control unit 107 activates an input SAM read signal (SIR) [to logic value 1 (H)], selects the data of the predetermined row of the input SAM unit 102 and accesses this, and further activates a memory access signal (SWA) and writes the accessed data into the memory cell (mentioned later) of the predetermined row of the data memory unit 103.

Next, in the horizontal scanning period, the program control unit 107 controls each processor element 110 based on the program and outputs data from the data memory unit 103 to the ALU array unit 104.

The ALU array unit 104 executes the arithmetic operation and the logical operation and writes the processing results at predetermined addresses of the data memory unit 103.

When the arithmetic operation and the logical operation according to the program are ended, the program control unit 107 controls the data memory unit 103 and transfers the processing results to the output SAM unit 105 in the next horizontal scanning period (the processing up to here is the second processing).

Further, in the next horizontal scanning period (third horizontal scanning period), it controls the output SAM unit 105 and outputs the processing results (output data) to the outside (third processing).

That is, one horizontal scanning period's worth of the input data stored in the input SAM unit 102 is, according to need, transferred to the data memory unit 103 and stored therein in the next horizontal scanning period for use for the processing in the horizontal scanning period thereafter.

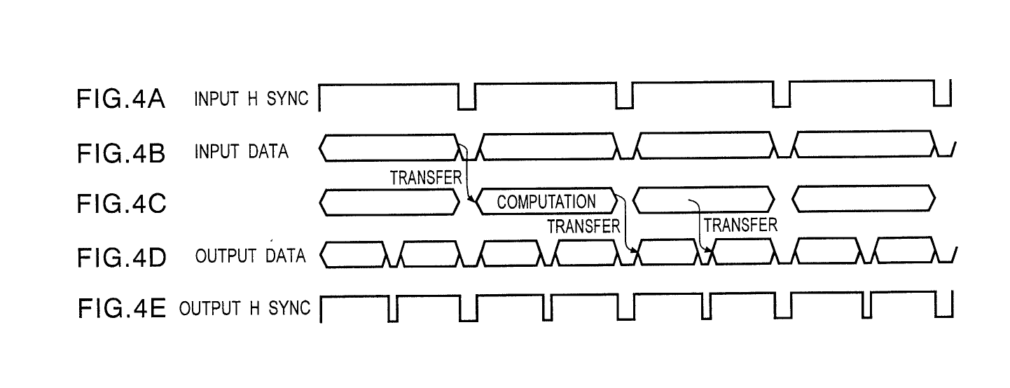

To summarize the main points, in the image DSP 11 according to the present embodiment, as shown in FIGS. 4A and 4B, in a horizontal scanning period, input data is input to the input SAM unit 102, as shown in FIG. 4C, IP conversion is performed in the ALU array unit 104, and output data is output from the output SAM unit 105.

Further, as shown in FIGS. 4B and 4C, in a horizontal blanking period, data input to the input SAM unit 102 is transferred to the data memory unit 103 inside the DSP 11, and as shown in FIG. 4C and 4D, the results of the IP conversion processed on the data memory unit 103 inside the DSP 11 and in the ALU array unit 104 are transferred to the output SAM unit 105.

This operation is performed in a pipeline manner.

Note that, due to features of the IP conversion, relative to the input of one line, the speed of output is doubled, that is, two lines are output.

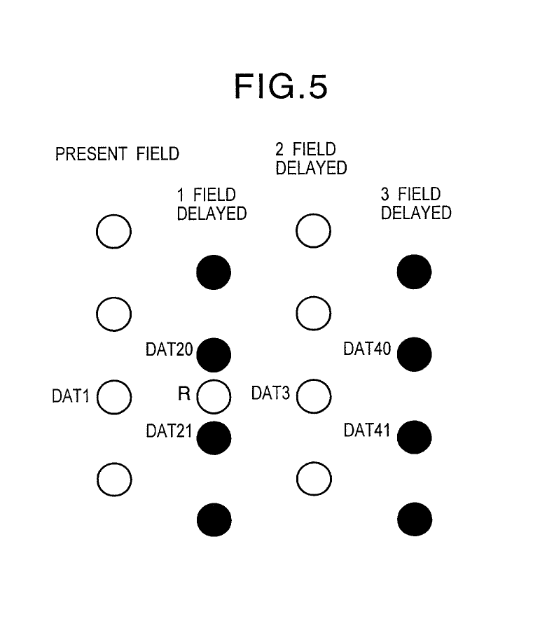

Next, an explanation will be made of the concrete processing of the IP conversion in the DSP 11 having the fundamental configuration as shown in FIG. 3 in relation to FIG. 5 to FIG. 15.

As described previously, the DSP 11 stores data DI1 to the input terminal I1 and data DI3 to the input terminal I3 in advance in its internal memory. As shown in FIG. 5, these data are denoted as DAT 1 and DAT 3.

Further, the DSP 11 stores two line's worth of data DI2 to the input terminal I2 and data DI4 to the input terminal I4 in advance in its internal memory. As shown in FIG. 5, these data are denoted as DAT 20, DAT 21, DAT 40, and DAT 41.

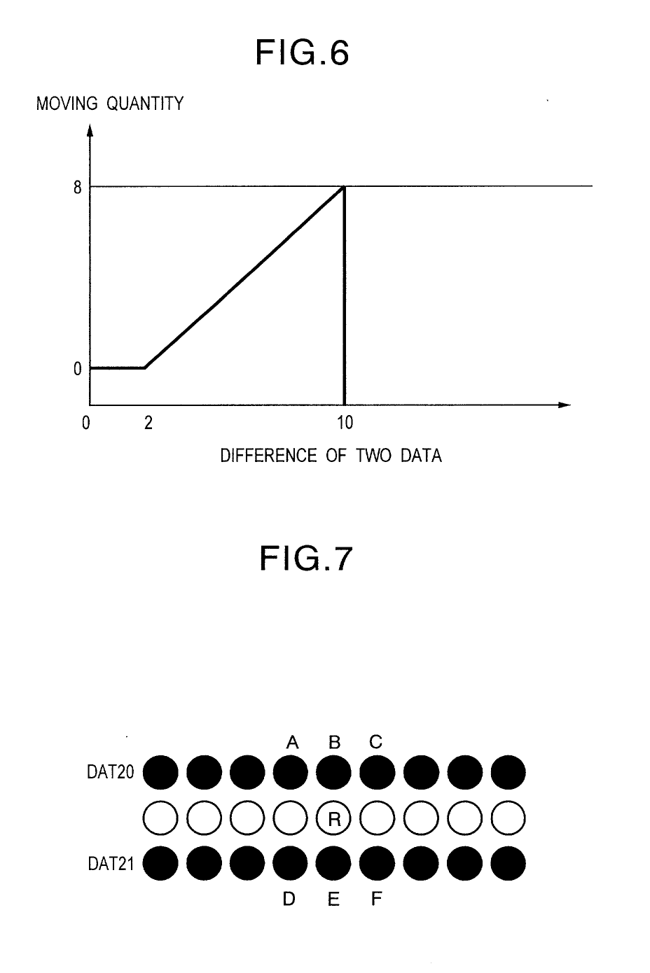

Further, a function for expressing a moving quantity by an absolute value of a difference of two data is, for example, determined in the manner shown in FIG. 6.

The moving quantity between data DAT 1 and DAT 3 is represented by MV1, DAT 20 and DAT 40 by MV2, and DAT 21 and DAT 41 by MV3. The maximum value of MV1, MV2, and MV3 is represented by MX1.

Next, for example, intra-field interpolation data is determined in the manner shown in FIG. 7.

Namely, the point to be determined by the intra-field interpolation is represented as R, the data in DAT 20 and upper left of R is represented by A, data in DAT 20 and just above R by B, data in DAT 20 and upper right of R by C, data in DAT 21 and lower left of R by D, data in DAT 21 and just below R by E, and data in DAT 21 and lower right of R by F.

If the absolute value of the difference of the values of data of B and E is less than a certain threshold value, R=(B+E)/2 is taken as the result of the intra-field interpolation.

If it is large, first, values of A, B, C, D, E, and F are listed in order of decreasing magnitude.

If the third largest value is M3 and the fourth is M4, R=(M3+M4)/2 is regarded as the result of the intra-field interpolation.

In addition, the moving quantity of R and DAR3 is represented by MVR, and the value of the larger one of MV1 and MVR is represented by MX2. The smaller one of the MX1 and MX2 is the value of the motion detection.

Finally, RES=(MX*R+DAT3*(8−MX))/8 is made the result of the IP conversion, and DAT 21 or DAT 20 and RES are output.

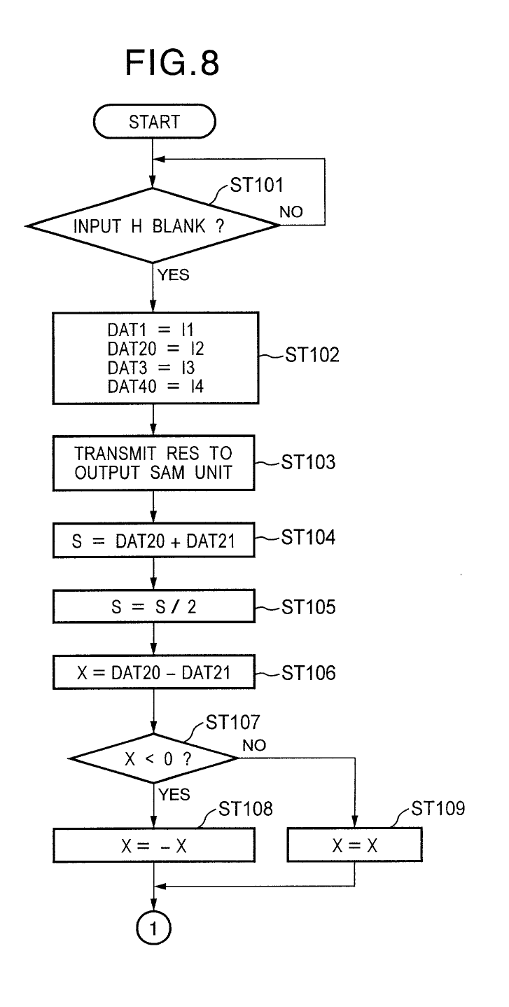

Below, an explanation will be made in more detail of the operation of the IP conversion according to the first embodiment with reference to the flow charts in FIG. 8 to FIG. 15.

In a horizontal blanking period (ST101), the following entry processing is carried out.

Data is substituted from the input SAM unit 102 for the variable DAT 1 on the data memory unit 103 inside the DSP 11, data is substituted from the input SAM unit 102 for the variable DAT 20 on the data memory unit 103 inside the DSP 11, data is substituted from the input SAM unit 102 for the variable DAT 3 on the data memory unit 103 inside the DSP 11, and data is substituted from the input SAM unit 102 for the variable DAT 40 on the data memory unit 103 inside the DSP 11 (ST102).

Next, the value of the variable RES on the data memory unit 103 inside the DSP 11 is transferred to the output SAM unit 105 (ST103).

The values of the variables DAT 20 and DAT 21 on the data memory unit 103 inside the DSP 11 are added, and the result is substituted for a variable S on the data memory unit 103 inside the DSP 11 (ST104).

The value of the variable S on the data memory unit 103 inside the DSP 11 is divided by 2 and is substituted for S (ST105).

The value of the variable DAT 21 on the data memory unit 103 inside the DSP 11 is subtracted from that of DAT 20 on the data memory unit 103 inside the DSP 11, and the result is substituted for a variable X in the data memory unit 103 inside the DSP 11 (ST106).

If X is negative (ST107), −X is substituted for X (ST108). If X is not negative (ST107), X is substituted for X (ST109).

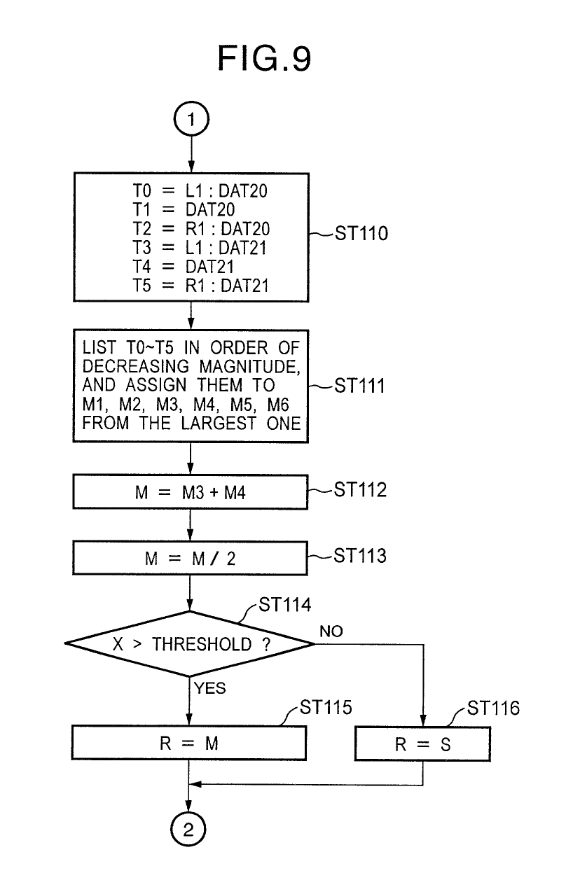

Next, the operation routine proceeds to the processing of step ST110 of FIG. 9.

At step ST110, the following processing is carried out.

The value of DAT 20 in the left adjacent processor element 110 is substituted for a variable T0 on the data memory unit 103 inside the DSP 11.

The value of DAT 20 is substituted for a variable T1 on the data memory unit 103 inside the DSP 11.

The value of DAT 20 in the right adjacent processor element 110 is substituted for a variable T2 on the data memory unit 103 inside the DSP 11.

The value of DAT 21 in the left adjacent processor element 110 is substituted for a variable T3 on the data memory unit 103 inside the DSP 11.

The value of DAT 21 is substituted for a variable T4 on the data memory unit 103 inside the DSP 11.

The value of DAT 21 in the right adjacent processor element 110 is substituted for a variable T5 on the data memory unit 103 inside the DSP 11.

Next, variables T0 to T5 are listed in order of decreasing magnitude of their values, and their values are substituted for variables M1, M2, M3, M4, M5, and M6 on the data memory unit 103 inside the DSP 11 (ST111).

Next, the values of M3 and M4 are added, and the result is substituted for a variable M on the data memory unit 103 inside the DSP 11 (ST112).

The value of the variable M on the data memory unit 103 inside the DSP 11 is divided by 2, and the result is substituted for M (ST113).

If the value of the variable X on the data memory unit 103 inside the DSP 11 is greater than a certain threshold (ST114), the value of the variable M on the data memory unit 103 inside the DSP 11 is substituted for a variable R on the data memory unit 103 inside the DSP 11 (ST115)

Contrary to this, if the value of the variable X on the data memory unit 103 inside the DSP 11 is not greater than the threshold (ST114), the value of the variable S on the data memory unit 103 inside the DSP 11 is substituted for the variable R on the data memory unit 103 inside the DSP 11 (ST116).

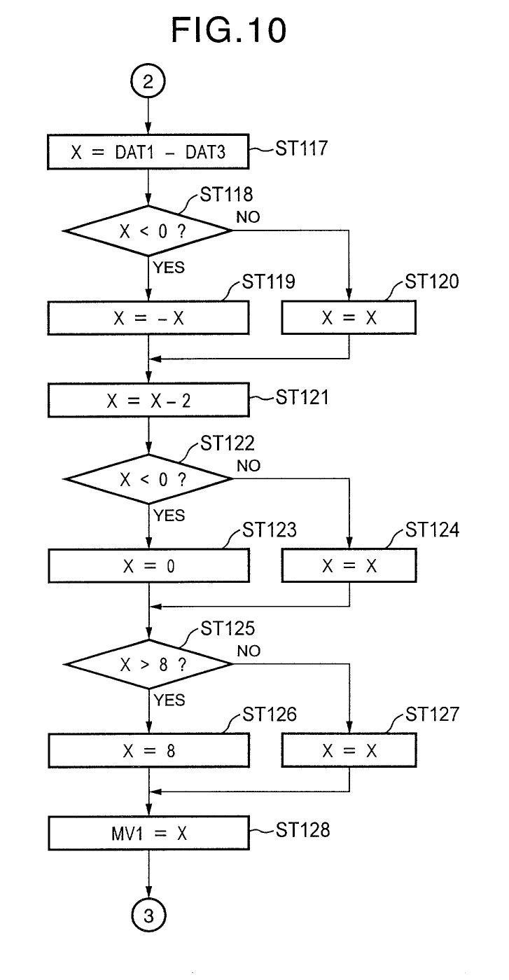

Next, the operation routine proceeds to the processing of step ST117 of FIG. 10.

At step ST117, the value of the variable DAT 3 on the data memory unit 103 inside the DSP 11 is subtracted from the value of the variable DAT 1 on the data memory unit 103 inside the DSP 11, and the result is substituted for a variable X on the data memory unit 103 inside the DSP 11.

If X is negative (ST118), −X is substituted for X (ST119). If X is not negative (ST118), X is substituted for X (ST124).

Next, X is subtracted by 2 (ST121).

If X is negative (ST122), 0 is substituted for X (ST123). If X is not negative (ST122), X is substituted for X (ST124).

Furthermore, if X is greater than 8 (ST125), 8 is substituted for X (ST126). If X is not greater than 8 (ST125), X is substituted for X (ST127).

Then, X is substituted for the variable MV1 on the data memory unit 103 inside the DSP 11 (ST128).

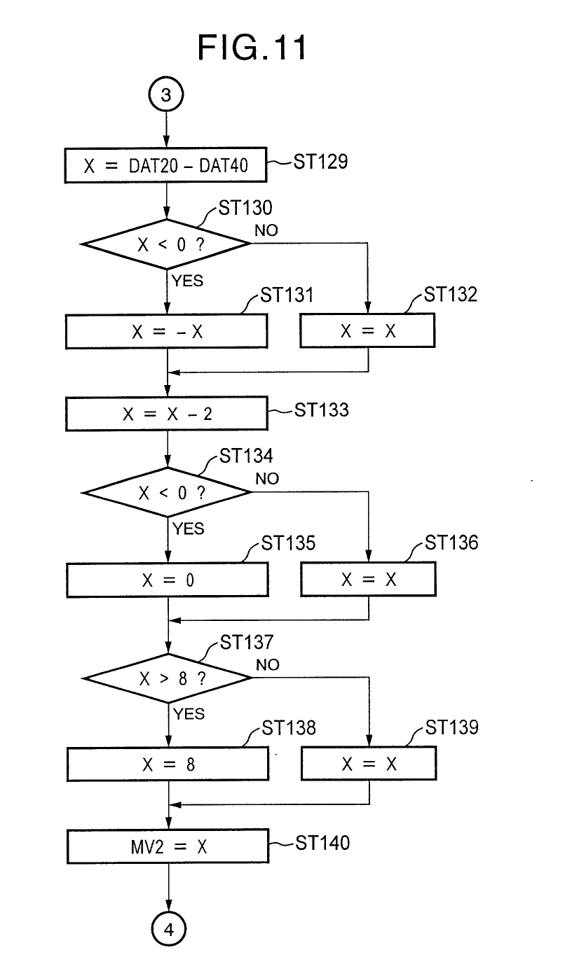

Next, the operation routine proceeds to the processing of step ST129 of FIG. 11.

At step ST129, the value of the variable DAT 40 on the data memory unit 103 inside the DSP 11 is subtracted from the value of the variable DAT 20 on the data memory unit 103 inside the DSP 11, and the result is substituted for a variable X on the data memory unit 103 inside the DSP 11.

If X is negative (ST130), −X is substituted for X (ST131). If X is not negative (ST130), X is just substituted for X (ST132).

Next, X is subtracted by 2 (ST133).

If X is negative (ST134), 0 is substituted for X (ST135). If X is not negative (ST134), X is substituted for X (ST136).

Furthermore, if X is greater than 8 (ST137), 8 is substituted for X (ST138). If X is not greater than 8 (ST137), X is substituted for X (ST139).

Then, X is substituted for the variable MV2 on the data memory unit 103 inside the DSP 11 (ST140).

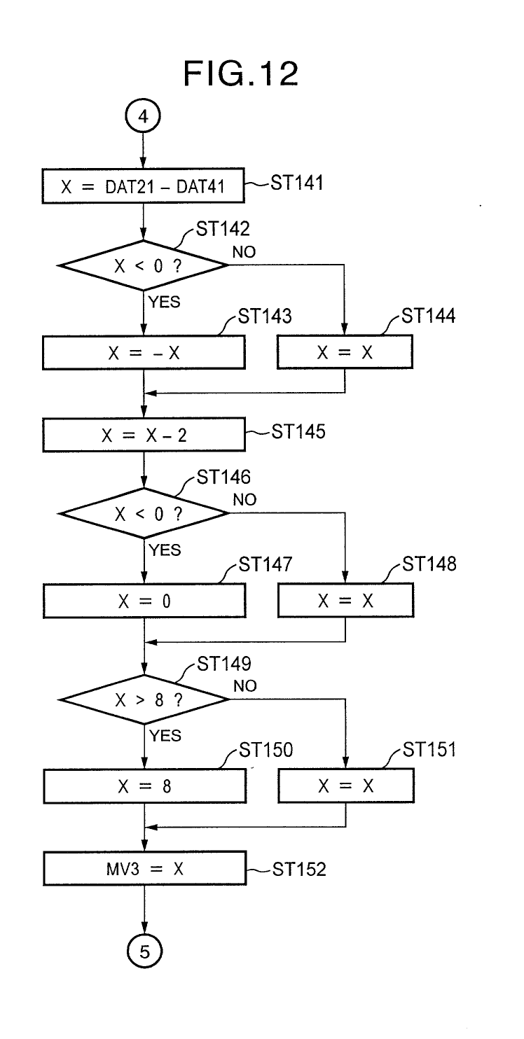

Next, the operation routine proceeds to the processing of step ST141 of FIG. 12.

At step ST141, the value of the variable DAT 41 on the data memory unit 103 inside the DSP 11 is subtracted from the value of the variable DAT 21 on the data memory unit 103 inside the DSP 11, and the result is substituted for a variable X on the data memory unit 103 inside the DSP 11.

If X is negative (ST142), −X is substituted for X (ST143). If X is not negative (ST142), X is substituted for X (ST144).

Next, X is subtracted by 2 (ST145).

If x is negative (ST146), 0 is substituted for X (ST147). If X is not negative (ST146), X is substituted for X (ST148).

Furthermore, if X is greater than 8 (ST1149), 8 is substituted for X (ST150). If X is not greater than 8 (ST149), X is substituted for X (ST151).

Then, X is substituted for the variable MV3 on the data memory unit 103 inside the DSP 11 (ST152).

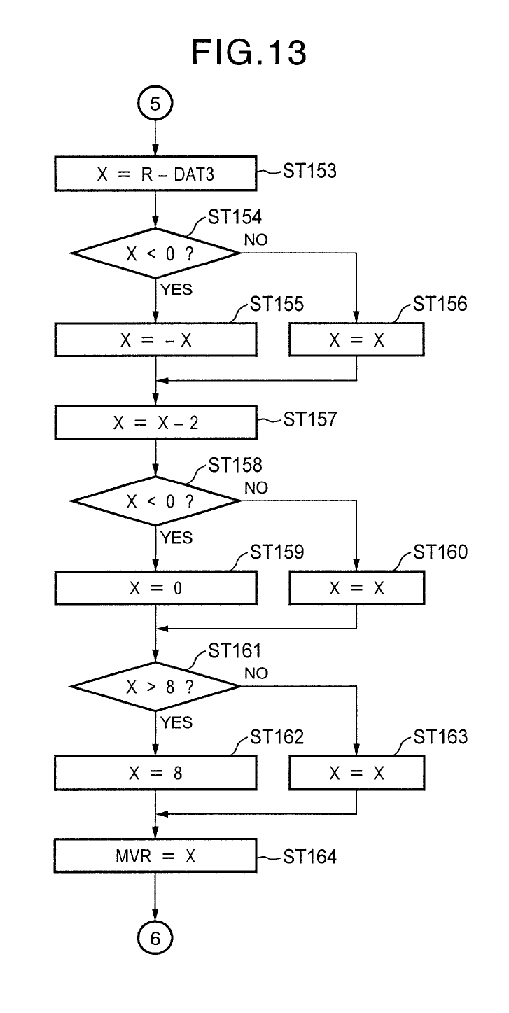

Next, the operation routine proceeds to the processing of the step ST153 of FIG. 13.

At step ST153, the value of the variable DAT 3 on the data memory unit 103 inside the DSP 11 is subtracted from the value of the variable R on the data memory unit 103 inside the DSP 11, and the result is substituted for a variable X on the data memory unit 103 inside the DSP 11 (ST153).

If X is negative (ST154), −X is substituted for X (ST155). If X is not negative (ST154), X is substituted for X (ST156).

Next, X is subtracted by 2 (ST157).

If X is negative (ST158), 0 is substituted for X (ST159). If X is not negative (ST158), X is substituted for X (ST160).

Furthermore, if X is greater than 8 (ST161), 8 is substituted for X (ST162). If X is not greater than 8 (ST161), X is substituted for X (ST163).

Then, X is substituted for the variable MVR on the data memory unit 103 inside the DSP 11 (ST164).

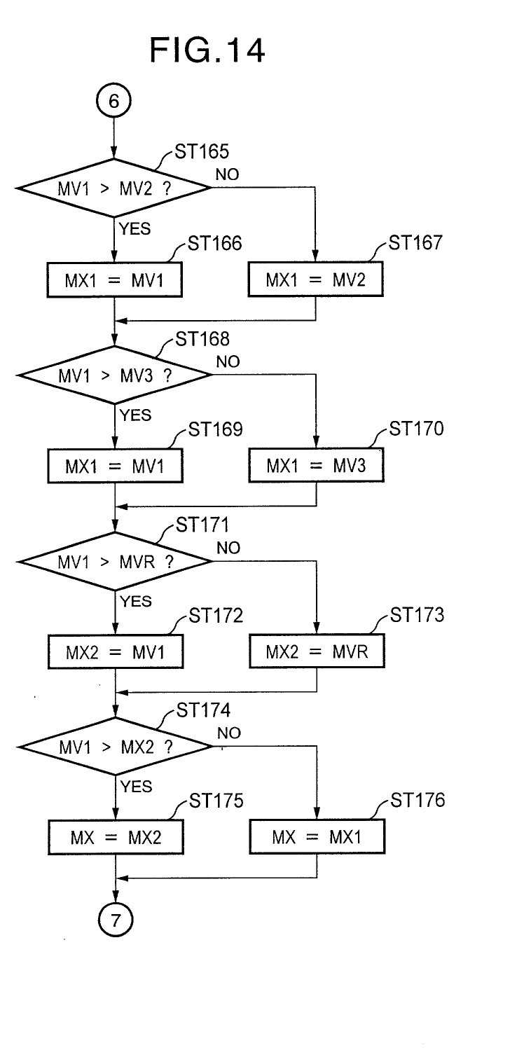

Next, the operation routine proceeds to the processing of step ST165 of FIG. 14.

At step ST165, the value of the variable MV1 on the data memory unit 103 inside the DSP 11 is compared with the value of the variable MV2 on the data memory unit 103 inside the DSP 11.

Then, if MV1>MV2, MV1 is substituted for a variable MX1 on the data memory unit 103 inside the DSP 11 (ST166). If MV1 is not greater than MV2, MV2 is substituted for the variable MX1 on the data memory unit 103 inside the DSP 11 (ST167).

Next, the value of the variable MX1 on the data memory unit 103 inside the DSP 11 is compared with the value of the variable MV3 on the data memory unit 103 inside the DSP 11 (ST168). If MX1>MV3, MV1 is substituted for the variable MX1 on the data memory unit 103 inside the DSP 11 (ST169). If MX1 is not greater than MV3, MV3 is substituted for the variable MX1 on the data memory unit 103 inside the DSP 11 (ST170).

Next, the value of the variable MV1 on the data memory unit 103 inside the DSP 11 is compared with the value of the variable MVR on the data memory unit 103 inside the DSP 11 (ST171). If MV1>MVR, MV1 is substituted for a variable MX2 on the data memory unit 103 inside the DSP 11 (ST172). If MV1 is not greater than MVR, MVR is substituted for the variable MX2 on the data memory unit 103 inside the DSP 11 (ST173).

Next, the value of the variable MX1 on the data memory unit 103 inside the DSP 11 is compared with the value of the variable MX2 on the data memory unit 103 inside the DSP 11 (ST174). If MX1>MX2, MX2 is substituted for a variable MX on the data memory unit 103 inside the DSP 11 (ST175). If MX1 is not greater than MX2, MX1 is substituted for the variable MX on the data memory unit 103 inside the DSP 11 (ST176).

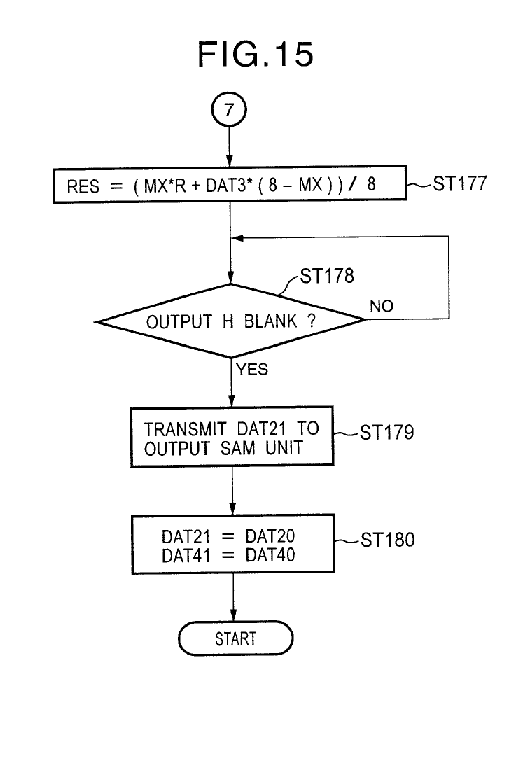

Next, the operation routine proceeds to the processing of step ST177 of FIG. 15.

At step ST177, (MX*R+DAT3*(8−MX))/8 is calculated, and the result is substituted for the variable RES on the data memory unit 103 inside the DSP 11 (ST177).

Then, in a horizontal blanking period of output (ST178), the value of the variable DAT21 on the data memory unit 103 inside the DSP 11 is transferred to the output SAM unit 105 (ST179).

Next, the value of the variable DAT20 on the data memory unit 103 inside the DSP 11 is substituted for the variable DAT21 on the data memory unit 103 inside the DSP 11 (ST180).

The value of the variable DAT40 on the data memory unit 103 inside the DSP 11 is substituted for the variable DAT41 on the data memory unit 103 inside the DSP 11 (ST180).

Then the operation routine is returned to step ST101 of FIG. 8, and the above process is repeated.

As explained above, according to the present embodiment, since there is provided a DSP 11 which detects motion at the time of conversion image data from an interlace signal to a progressive signal by using data of a present field, one-field delayed data, two-field delayed data, and three-field delayed data, deciding a function for expressing a moving quantity by an absolute value of a difference of two of the data, finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position as the pixel B after a three-field delay, and a moving quantity of data of a pixel C after a one-field delay one line below the pixel R whose motion is to be detected and data of a pixel F at the same position as the pixel C after a three-field delay, finding a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay, and using the smaller one of the two larger values as the moving quantity of the pixel R whose motion is to be detected, erroneous detection can be prevented, and IP conversion can be carried out at a high accuracy without the necessity of expanding a moving area in order to perform motion detection correctly in units of pixels.

Second Embodiment

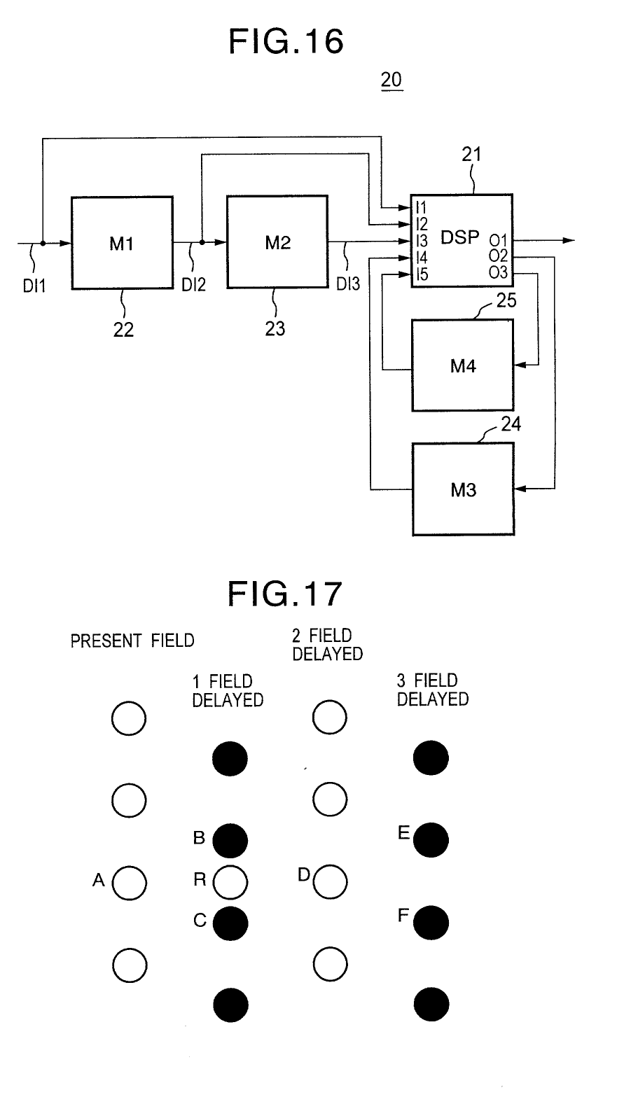

FIG. 16 is a block diagram of a second embodiment of an image signal processing apparatus according to the present invention.

The image signal processing apparatus 20, as shown in FIG. 16, comprises as main constitutional elements a DSP 21 serving as a processing means, memories 22 and 23 for generating one-field delay, a memory 24 for storing the moving quantity calculated and determined from the data of the present field and the two-field delayed data, and memory 25 for storing the count of motion detection.

Memories 22 (M1) and 23 (M2) for generating one field's worth of delay are arranged at the input stage of the image data of the DSP 21. In addition, memories 24 (M3) and 25 (M4) are arranged between the input terminal and output terminal of the DSP 21.

The input line of the image data is connected to an input terminal of the memory 22 and a first input terminal (I1) of the DSP 21.

An output terminal of the memory 22 is connected to the input terminal of the memory 23 and a second input terminal (I2) of the DSP 21.

An output terminal of the memory 23 is connected to a third input terminal (I3) of the DSP 21.

The input terminal of the memory 24 is connected to a second output terminal (O2) of the DSP 21 for outputting the moving quantity obtained by calculation of the DSP 21, and the output terminal of the memory 24 is connected to a fourth input terminal (I4) of the DSP 21.

The input terminal of the memory 25 is connected to a third output terminal (O3) of the DSP 21 for outputting the count of motion detection of the DSP 21, and the output terminal of the memory 25 is connected to a fifth input terminal (I5) of the DSP 21.

The DSP 21 stores in its internal memory data DI1 to the input terminal I1 and data DI3 to the input terminal I3.

Further, the DSP 21 stores in its internal memory two line's worth of data DI2 to the input terminal I2 and data DI4 to the input terminal I4.

The DSP 21, in the same way as the DSP 11 according to the first embodiment, performs the IP (interlace/progressive) conversion of an image signal of an image source from an interlace signal to a progressive signal based on parameters provided by a not illustrated control system.

At the time of conversion of image data from an interlace signal to a progressive signal, the DSP 21 performs motion detection in the following way.

That is, the DSP 21 uses data of a present field and two-field delayed data to determine a function for expressing a moving quantity by an absolute value of a difference of the two data. The DSP 21 finds a moving quantity of data of a pixel A in the present field at the same position as a pixel R whose motion is to be detected and data of a pixel D at the same position after a two-field delay, writes this value into the memory 24, and reads out from the memory 24 a moving quantity of data of a pixel B after a one-field delay one line above a pixel R whose motion is to be detected of one field before and data of a pixel E at the same position after a three-field delay and a moving quantity of data of a pixel C after a one-field delay one line below the pixel R whose motion is to be detected and data of a pixel F at the same position after a three-field delay. The DSP 21 uses these moving quantities to detect motion. By this process, by only data delayed at most by two fields, the same result is obtained as that when more data are used.

Further, the DSP 21 finds a moving quantity (first moving quantity) of the data of the pixel A in the present field at the same position as the pixel R whose motion is to be detected and the data of the pixel D at the same position after a two-field delay and writes this moving quantity into the memory 24. From the memory 24, the DSP 21 reads out a moving quantity (second moving quantity) of the data of the pixel B after a one-field delay one line above the pixel R whose motion is to be detected of one field before and the data of the pixel E at the same position after a three-field delay and a moving quantity (third moving quantity) of the data of the pixel C after a one-field delay one line below the pixel R whose motion is to be detected and the data of the pixel F at the same position after a three-field delay. Further, the DSP 21 finds the maximum value (fourth moving quantity) of the first moving quantity and the second moving quantity and the maximum value (fifth moving quantity) of the first moving quantity and the third moving quantity and uses the minimum value of the fourth moving quantity and fifth moving quantity as the moving quantity of the pixel. The DSP 21 uses the data obtained by intra-field interpolation from pixels B and C at lines above and below the pixel R whose motion is to be detected for a place of large moving quantity and uses the data of the pixel D at the same position after a two-field delay for a place of small moving quantity.

Further, the DSP 21 finds a moving quantity (first moving quantity) of the data of the pixel A in the present field at the same position as the pixel R whose motion is to be detected and the data of the pixel D at the same position after a two-field delay and writes this moving quantity into the memory 24. Further, the DSP 21 reads out from the memory 24 a moving quantity (second moving quantity) of the data of the pixel B after a one-field delay one line above the pixel R whose motion is to be detected of one field before and the data of the pixel E at the same position after a three-field delay and a moving quantity (third moving quantity) of the data of the pixel C after a one-field delay one line below the pixel R whose motion is to be detected and the data of the pixel F at the same position after a three-field delay. In addition, the DSP 21 finds the maximum value (fourth moving quantity) of the first moving quantity and second moving quantity, the maximum value (fifth moving quantity) of the first moving quantity and third moving quantity, the minimum value (sixth moving quantity) of the fourth moving quantity and fifth moving quantity, the maximum value (eighth moving quantity) of a moving quantity (seventh moving quantity) of data obtained by intra-field interpolation from pixels B and C at lines above and below the pixel R whose motion is to be detected and the data of the pixel D at the same position after a two-field delay and moving quantity (first moving quantity) of the data of the pixel A in the present field at the same position as the pixel R whose motion is to be detected and the data of the pixel D at the same position after a two-field delay. By a function from the sixth moving quantity, if the sixth moving quantity is greater than a certain threshold value, the DSP 21 writes a specific initial value to the memory 25 for storing one screen's worth of values. Otherwise the DSP 21 reduces the data read from the memory 25 by 1. If the result is less than 0, the DSP 21 writes zero to the memory 25. If the value is zero, the sixth moving quantity is used as the result of motion detection, otherwise the eighth moving quantity is used as the result of motion detection. The DSP 21 uses the data obtained by intra-field interpolation from pixels B and C at lines above and below the pixel R whose motion is to be detected for a place of large moving quantity and uses the data of the pixel D at the same position after a two-field delay for a place of small moving quantity.

The DSP 21 uses the data obtained by intra-field interpolation from pixels B and C at lines above and below the pixel R whose motion is to be detected for a place of large moving quantity and uses an average of the data of the pixel A at the same position in the present field and the data of the pixel D at the same position after a two-field delay for a place of small moving quantity.

Furthermore, when determining intra-field interpolation data, if the absolute value of the difference of the data at immediately upper and lower positions in lines above and below is less than a certain threshold value, the DSP 21 interpolates by using the average value of the data at immediately upper and lower positions in lines above and below, otherwise, the DSP 21 interpolates by using the average value of the data of two central values among a number of pixels in the vicinity of the lines above and below (six pixels nearby in the present invention).

The DSP 21 having the above IP conversion functions, similar to the DSP 11 according to the first embodiment, is configured by a SIMD control processor as explained with reference to FIG. 3 and FIG. 4, so a detailed explanation is omitted here.

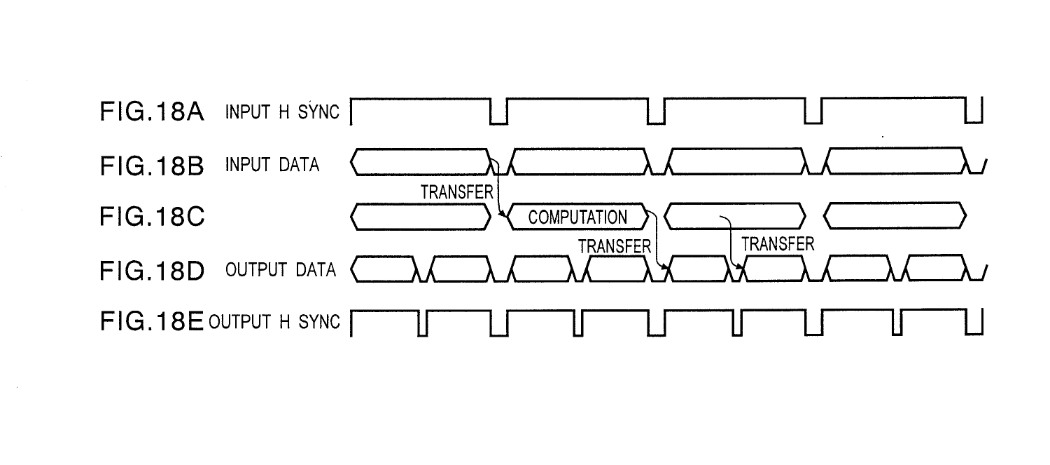

As the basic operation, similar to the DSP 11 according to the first embodiment, as shown in FIGS. 18A to 18E, in the image DSP 21, in a horizontal scanning period, input data is input to the input SAM unit 102, IP conversion is performed in the ALU array unit 104, and output data is output from the output SAM unit 105.

Further, in a horizontal blanking period, data input to the input SAM unit 102 is transferred to the data memory unit 103 inside the DSP 21, and the results of the IP conversion processed on the data memory unit 103 inside the DSP 21 and in the ALU array unit 104 are transferred to the output SAM unit 105.

This operation is performed in a pipeline manner.

Note that, due to the features of the IP conversion, relative to input of one line, the speed of output is doubled, that is, two lines are output.

Next, an explanation will be made of the concrete processing of the IP conversion in the DSP 21 according to the second embodiment in relation to FIG. 3 and FIG. 19 to FIG. 28.

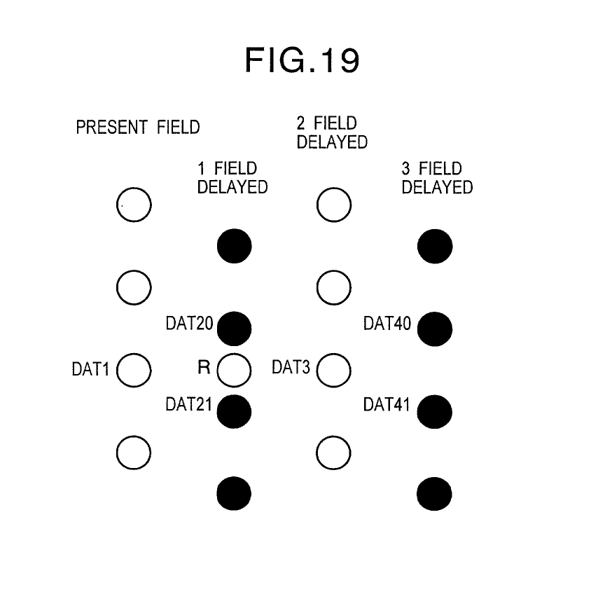

As described previously, the DSP 21 stores data DI1 to the input terminal I1 and data DI3 to the input terminal I3 in its internal memory. As shown in FIG. 19, these data are denoted as DAT 1 and DAT 3.

Further, the DSP 21 stores two line's worth of data DI2 to the input terminal I2 in its internal memory. As shown in FIG. 19, these data are denoted as DAT 20 and DAT 21.

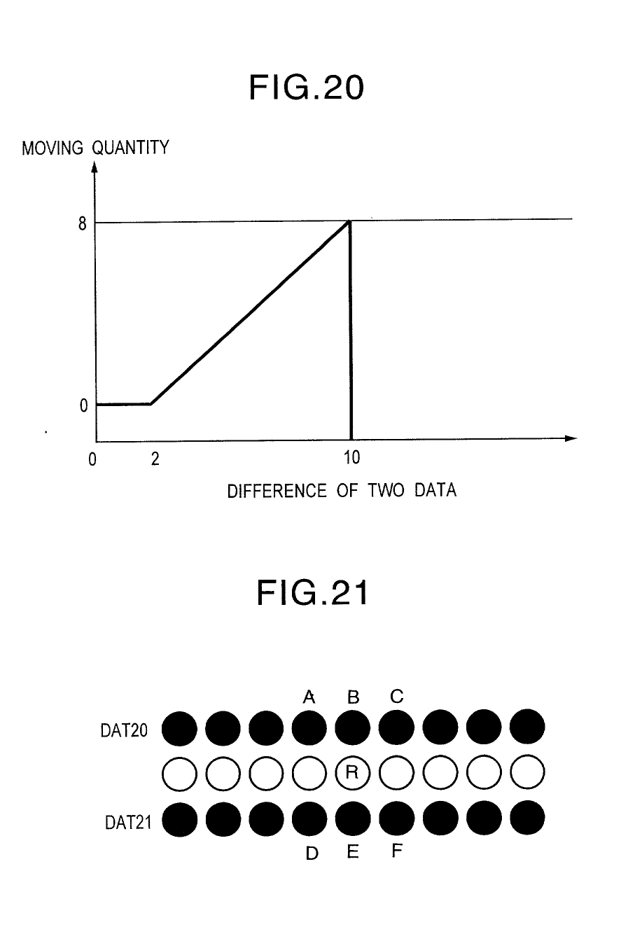

Further, a function for expressing a moving quantity by an absolute value of a difference of two data is, for example, determined in the manner shown in FIG. 20.

The moving quantity between data DAT 1 and DAT 3 is represented by MV1 and is output from the second output terminal O2 of the DSP 21.

With the value of MV1 about one field earlier and stored in the memory 24, a value corresponding to the moving quantity between data DAT 20 and DAT 40 in FIG. 19 and value corresponding to the moving quantity between data DAT 21 and DAT 41 are read out from the memory 24 through the fourth input terminal I4 and are denoted as MV2 and MV3, respectively.

The maximum value of MV1 and MV2 is represented by MX1, the maximum value of MV1 and MV3 is represented by MX2, and the minimum value of MX1 and MX2 is represented by MX3.

Next, for example, intra-field interpolation data is determined in the manner shown in FIG. 21.

Namely, the point to be determined by the intra-field interpolation is represented as R, the data in DAT 20 and the upper left of R is represented by A, data in DAT 20 and just above R by B, data in DAT 20 and the upper right of R by C, data in DAT 21 and the lower left of R by D, data in DAT 21 and just below R by E, and data in DAT 21 and the lower right of R by F.

If the absolute value of the difference of the values of data of B and E is less than a certain threshold value, R=(B+E)/2 is taken as the result of the intra-field interpolation.

If it is large, first, values of A, B, C, D, E, and F are listed in order of decreasing magnitude.

If the third largest value is M3 and the fourth is M4, R=(M3+M4)/2 is regarded as the result of the intra-field interpolation.

In addition, the moving quantity of R and DAT3 is denoted as MVR, and the value of the larger one of MV1 and MVR is denoted as MX4.

If MX3 becomes 8, CD equals 4.

If MX3 is less than 8, the value of CD at the same position in the preceding field is read out from the memory 25 and is reduced by 1. If CD is less than 0, CD is made 0 and substituted for CD.

The value of CD obtained in this way is output to the memory 25 from the third output terminal O3 of the DSP 21.

If CD becomes zero, MX3 is substituted for MX.

If CD is greater than 0, MX4 is substituted for MX.

Finally, RES=(MX*R+DAT3*(8−MX))/8 is made the result of the IP conversion, and DAT 21 or DAT 30 and RES are output.

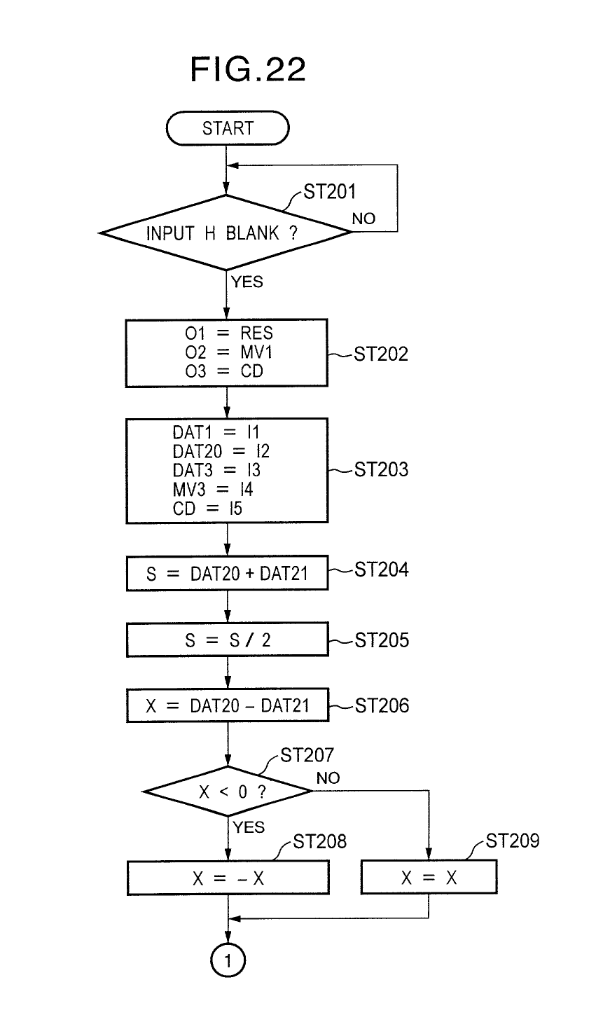

Below, an explanation will be made in more detail of the operation of the IP conversion according to the second embodiment with reference to the flow charts in FIG. 22 to FIG. 28.

In a horizontal blanking period (ST201), the following transfer and substitution processing is carried out first.

First, at step ST202, the following transfer processing is carried out.

The value of the variable RES on the data memory unit 103 inside the DSP 21 is transferred to the output SAM unit 105 (the first output terminal O1).

The value of the variable MV1 on the data memory unit 103 inside the DSP 21 is transferred to the output SAM unit 105 (the second output terminal O2).

The value of the variable CD on the data memory unit 103 inside the DSP 21 is transferred to the output SAM unit 105 (the third output terminal O3).

Next, at step ST203, the following entry processing is carried out.

The value of data from the input SAM unit 102 (the first input terminal I1) is substituted for the variable DAT 1 on the data memory unit 103 inside the DSP 21.

The value of data from the input SAM unit 102 (the second input terminal I2) is substituted for the variable DAT 20 on the data memory unit 103 inside the DSP 21.

The value of data from the input SAM unit 102 (the third input terminal I3) is substituted for the variable DAT 3 on the data memory unit 103 inside the DSP 21.

The value of data from the input SAM unit 102 (the fourth input terminal I4) is substituted for the variable MV3 on the data memory unit 103 inside the DSP 21.

The value of data from the input SAM unit 102 (the fifth input terminal I5) is substituted for the variable CD on the data memory unit 103 inside the DSP 21.

The values of the variables DAT 20 and DAT 21 on the data memory unit 103 inside the DSP 21 are added, and the result is substituted for a variable S on the data memory unit 103 inside the DSP 21 (ST204).

The value of the variable S on the data memory unit 103 inside the DSP 21 is divided by 2 and is substituted for S (ST205).

The value of the variables DAT 21 on the data memory unit 103 inside the DSP 21 is subtracted from that of DAT 20 on the data memory unit 103 inside the DSP 21, and the result is substituted for a variable X in the data memory unit 103 inside the DSP 21 (ST206).

If X is negative (ST207), −X is substituted for X (ST208). If X is not negative (ST207), X is substituted for X (ST209).

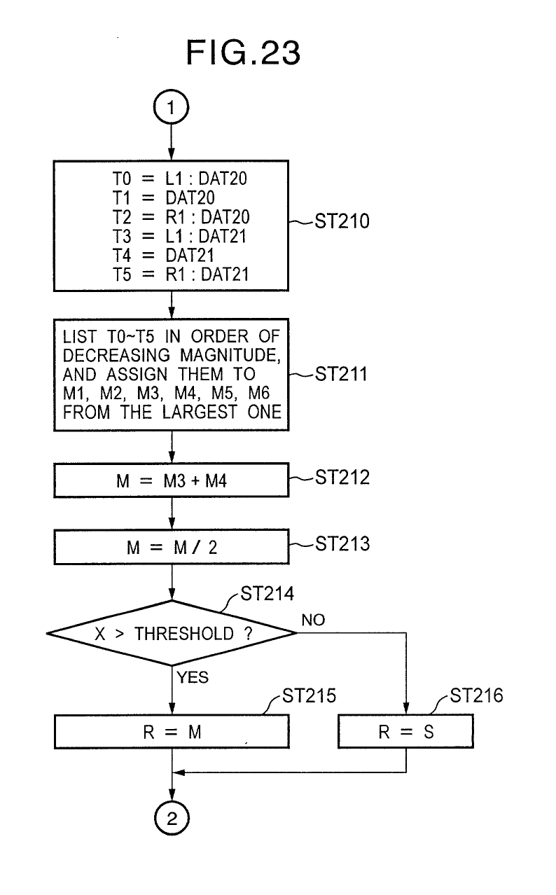

Next, the operation routine proceeds to the processing of step ST210 of FIG. 23.

At step ST210, the following processing is carried out.

The value of DAT 20 in the left adjacent processor element 110 is substituted for a variable T0 on the data memory unit 103 inside the DSP 21.

The value of DAT 20 is substituted for a variable T1 on the data memory unit 103 inside the DSP 21.

The value of DAT 20 in the right adjacent processor element 110 is substituted for a variable T2 on the data memory unit 103 inside the DSP 21.

The value of DAT 21 in the left adjacent processor element 110 is substituted for a variable T3 on the data memory unit 103 inside the DSP 21.

The value of DAT 21 is substituted for a variable T4 on the data memory unit 103 inside the DSP 21.

The value of DAT 21 in the right adjacent processor element 110 is substituted for a variable T5 on the data memory unit 103 inside the DSP 21.

Next, variables T0 to T5 are listed in order of decreasing magnitude of their values, and their values are substituted for variables M1, M2, M3, M4, M5, and M6 on the data memory unit 103 inside the DSP 21 (ST211).

Next, values of M3 and M4 are added, and the result is substituted for a variable M on the data memory unit 103 inside the DSP 21 (ST212).

The value of the variable M on the data memory unit 103 inside the DSP 21 is divided by 2, and the result is substituted for M (ST213).

If the value of the variable X on the data memory unit 103 inside the DSP 21 is greater than a certain threshold (ST214), the value of the variable M on the data memory unit 103 inside the DSP 21 is substituted for a variable R on the data memory unit 103 inside the DSP 21 (ST215).

Contrary to this, if the value of the variable X on the data memory unit 103 inside the DSP 21 is not greater than the threshold (ST214), the value of the variable S on the data memory unit 103 inside the DSP 21 is substituted for the variable R on the data memory unit 103 inside the DSP 21 (ST216).

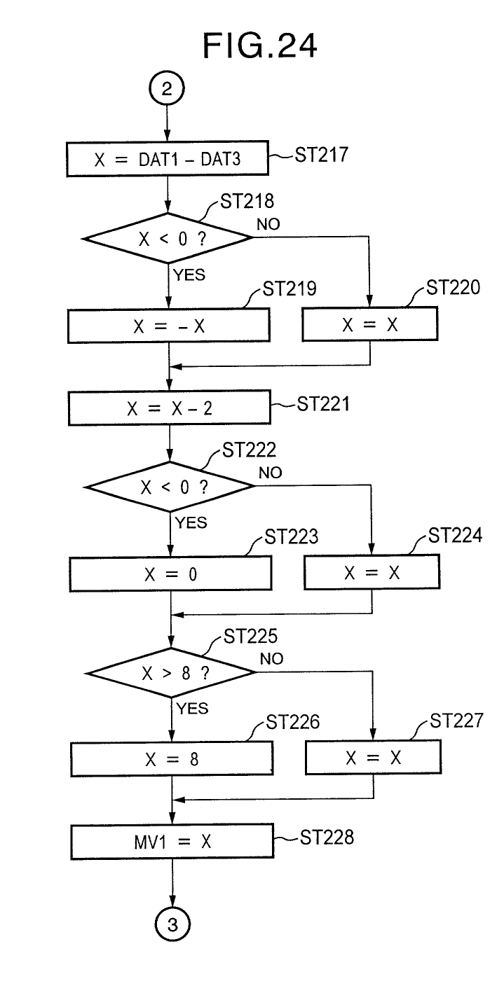

Next, the operation routine proceeds to the processing of step ST217 of FIG. 24.

At step ST217, the value of the variable DAT 3 on the data memory unit 103 inside the DSP 21 is subtracted from the value of the variable DAT 1 on the data memory unit 103 inside the DSP 21, and the result is substituted for a variable X on the data memory unit 103 inside the DSP 21.

If X is negative (ST218), −X is substituted for X (ST219). If X is not negative (ST218), X is substituted for X (ST220).

Next, X is subtracted by 2 (ST221).

If X is negative (ST222), 0 is substituted for X (ST223). If X is not negative (ST222), X is substituted for X (ST224).

Furthermore, if X is greater than 8 (ST225), 8 is substituted for X (ST226). If X is not greater than 8 (ST225), X is substituted for X (ST227).

Then, X is substituted for the variable MV1 on the data memory unit 103 inside the DSP 21 (ST228).

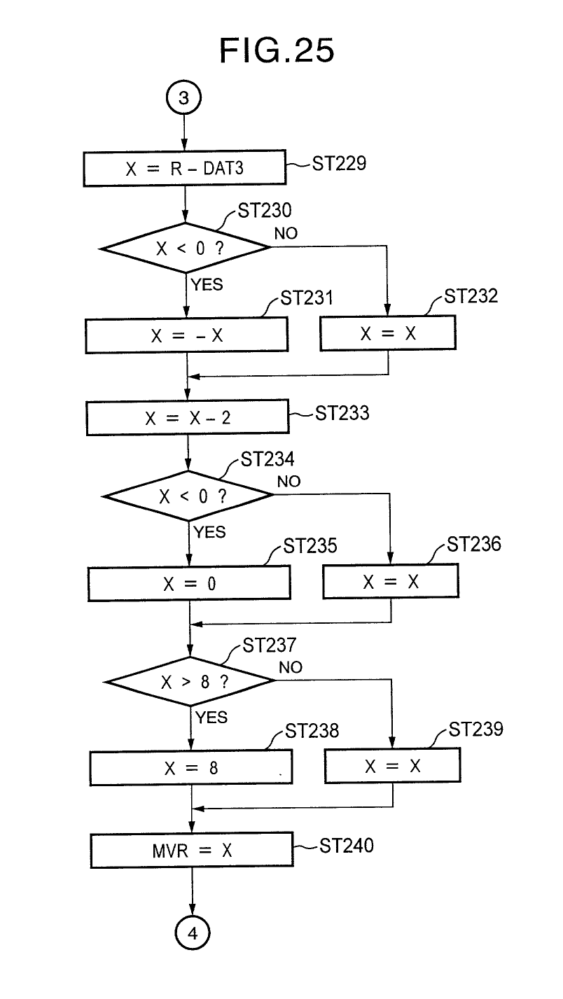

Next, the operation routine proceeds to the processing of step ST229 of FIG. 25.

At step ST229, the value of the variable DAT 3 on the data memory unit 103 inside the DSP 21 is subtracted from the value of the variable R on the data memory unit 103 inside the DSP 21, and the result is substituted for the variable X on the data memory unit 103 inside the DSP 21.

If X is negative (ST230), −X is substituted for X (ST231). If X is not negative (ST230), X is substituted for X (ST232).

Next, X is subtracted by 2 (ST233).

If X is negative (ST234), 0 is substituted for X (ST235). If X is not negative (ST234), X is substituted for X (ST236).

Furthermore, if X is greater than 8 (ST237), 8 is substituted for X (ST238). If X is not greater than 8 (ST237), X is substituted for X (ST239).

Then, X is substituted for the variable MVR on the data memory unit 103 inside the DSP 21 (ST240).

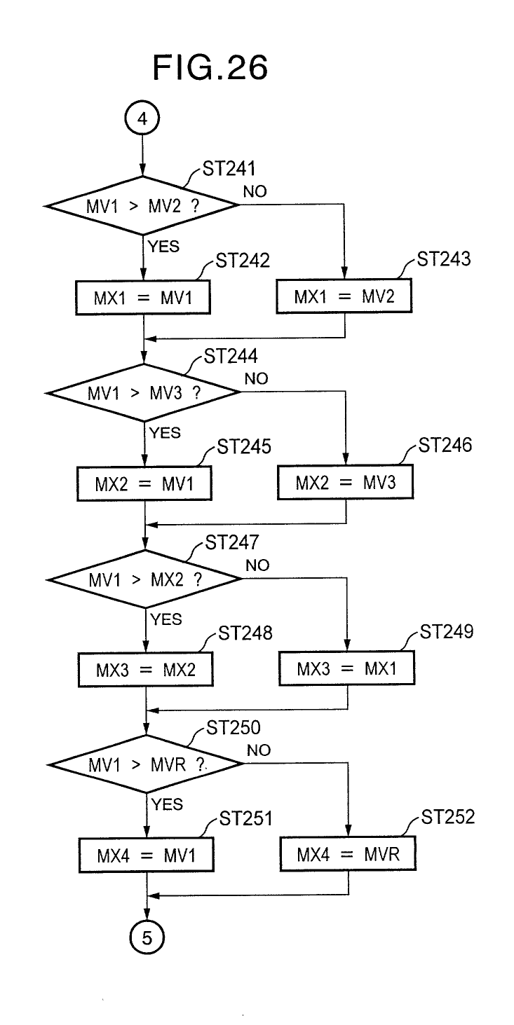

Next, the operation routine proceeds to the processing of step ST241 of FIG. 26.

At step ST241, the value of the variable MV1 on the data memory unit 103 inside the DSP 21 is compared with the value of the variable MV2 on the data memory unit 103 inside the DSP 21.

Then, if MV1>MV2, MV1 is substituted for a variable MX1 on the data memory unit 103 inside the DSP 21 (ST242). If MV1 is not greater than MV2, MV2 is substituted for the variable MX1 on the data memory unit 103 inside the DSP 21 (ST243).

Next, the value of the variable MV1 on the data memory unit 103 inside the DSP 21 is compared with the value of the variable MV3 on the data memory unit 103 inside the DSP 21 (ST244). If MV1>MV3, MV1 is substituted for the variable MX2 on the data memory unit 103 inside the DSP 21 (ST245). If MV1 is not greater than MV3, MV3 is substituted for the variable MX2 on the data memory unit 103 inside the DSP 21 (ST246).

Next, the value of the variable MX1 on the data memory unit 103 inside the DSP 21 is compared with the value of the variable MX2 on the data memory unit 103 inside the DSP 21 (ST247). If MX1>MX2, MX2 is substituted for a variable MX3 on the data memory unit 103 inside the DSP 21 (ST248). If MX1 is not greater than MX2, MX1 is substituted for the variable MX3 on the data memory unit 103 inside the DSP 21 (ST249).

Next, the value of the variable MV1 on the data memory unit 103 inside the DSP 21 is compared with the value of the variable MVR on the data memory unit 103 inside the DSP 21 (ST250). If MV1>MVR, MV1 is substituted for a variable MX4 on the data memory unit 103 inside the DSP 21 (ST251). If MV1 is not greater than MVR, MVR is substituted for the variable MX4 on the data memory unit 103 inside the DSP 21 (ST252).

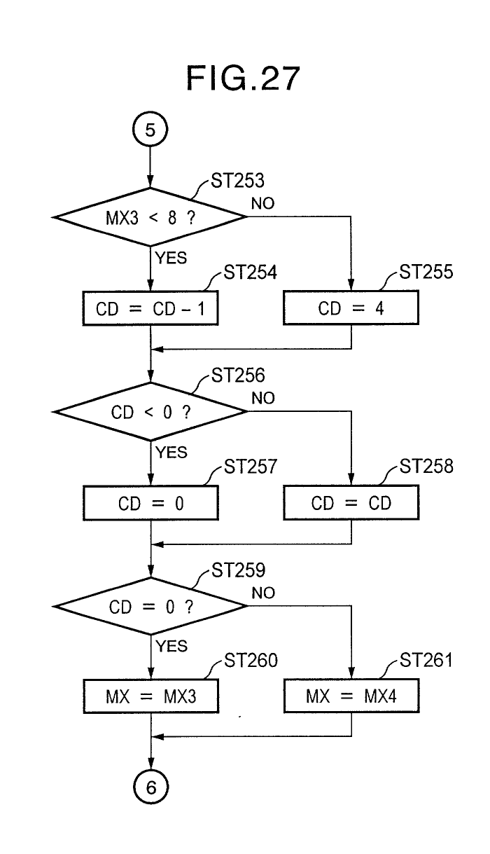

Next, the operation routine proceeds to the processing of step ST253 of FIG. 27.

At step ST253, the value of the variable MX3 on the data memory unit 103 inside the DSP 21 is compared with 8.

If the value of the variable MX3 on the data memory unit 103 inside the DSP 21 is less than 8, the value of the variable CD on the data memory unit 103 inside the DSP 21 is reduced by 1 (ST254). On the other hand, if the value of MX3 is not less than 8, 4 is substituted for the variable CD on the data memory unit 103 inside the DSP 21 (ST255).

Next, the value of the variable CD on the data memory unit 103 inside the DSP 21 is compared with 0 (ST256), and if the value of the variable CD on the data memory unit 103 inside the DSP 21 is less than 0, 0 is substituted for the variable CD on the data memory unit 103 inside the DSP 21 (ST257). If the value of CD is not less than 0, CD is substituted for CD (ST258).

Next, if the value of the variable CD on the data memory unit 103 inside the DSP 21 is 0, the value of MX3 is substituted for the variable MX on the data memory unit 103 inside the DSP 21 (ST259, ST260).

If the value of the variable CD on the data memory unit 103 inside the DSP 21 is greater than 0, the value of MX4 is substituted for the variable MX on the data memory unit 103 inside the DSP 21 (ST259, ST261).

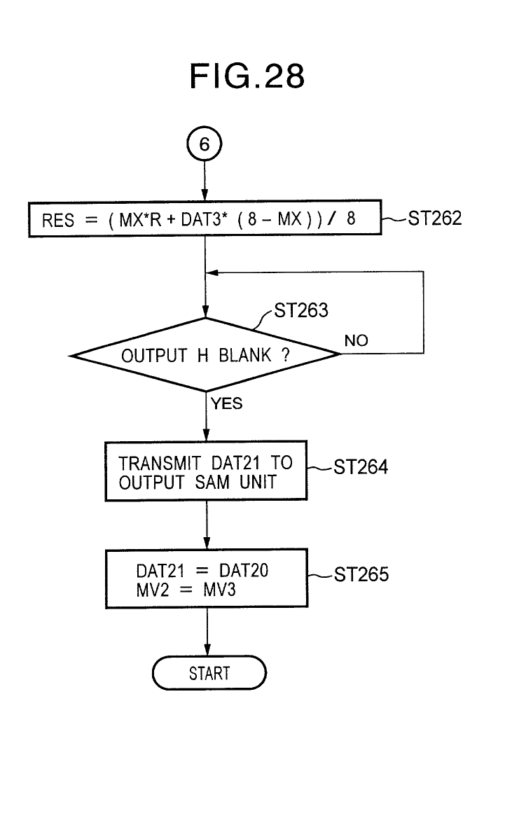

Then the operation routine proceeds to step ST262 of FIG. 28.

At step ST262, (MX*R+DAT3*(8−MX))/8 is calculated, and the result is substituted for the variable RES on the data memory unit 103 inside the DSP 21.

Then, in a horizontal blanking period of output (ST263), the value of the variable DAT 21 on the data memory unit 103 inside the DSP 21 is transferred to the output SAM unit 105 (ST264).

Next, the value of the variable DAT 20 on the data memory unit 103 inside the DSP 21 is substituted for the variable DAT 21 on the data memory unit 103 inside the DSP 21 (ST265).

The value of the variable MV3 on the data memory unit 103 inside the DSP 21 is substituted for the variable MV2 on the data memory unit 103 inside the DSP 21 (ST265).

Then the operation routine is returned to step ST201 of FIG. 22, and the above process is repeated.

According to the second embodiment, the same effects as the first embodiment described above can be achieved.

Note that, in the embodiments described above, explanations were made by taking as an example the case in which the processing means according to the present invention was comprised of a DSP, but the present invention is not limited to this. It is also possible to configure this by combining logic circuits.

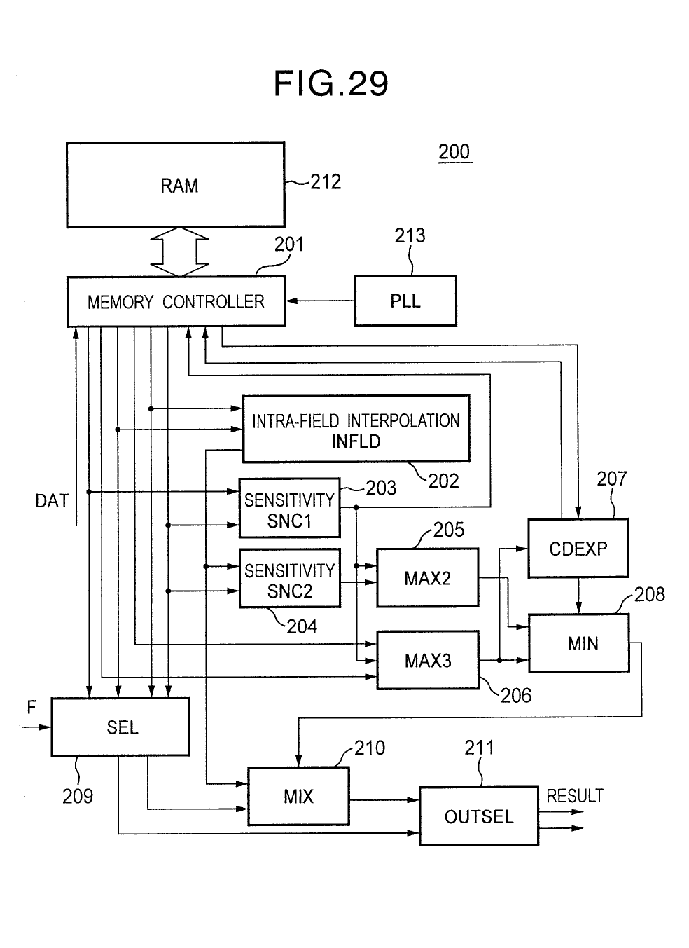

FIG. 29 is a block diagram of an example of the configuration of a processing means combining logic circuits according to the present invention.

This processing means 200 is comprised of a memory controller 201, intra-field interpolation (INFLD) block 202, first sensitivity (SNC1) block 203, second sensitivity (SNC2) block 204, comparison (MAX2) block 205, comparison (MAX3) block 206, processing (CDEXP) block 207, processing (MIN) block 208, selection (SEL) block 209, computation (MIX) block 210, output (OUTSEL) block 211, RAM 212, and PLL block 213.

The functions of each part will be explained next.

Memory Controller 201

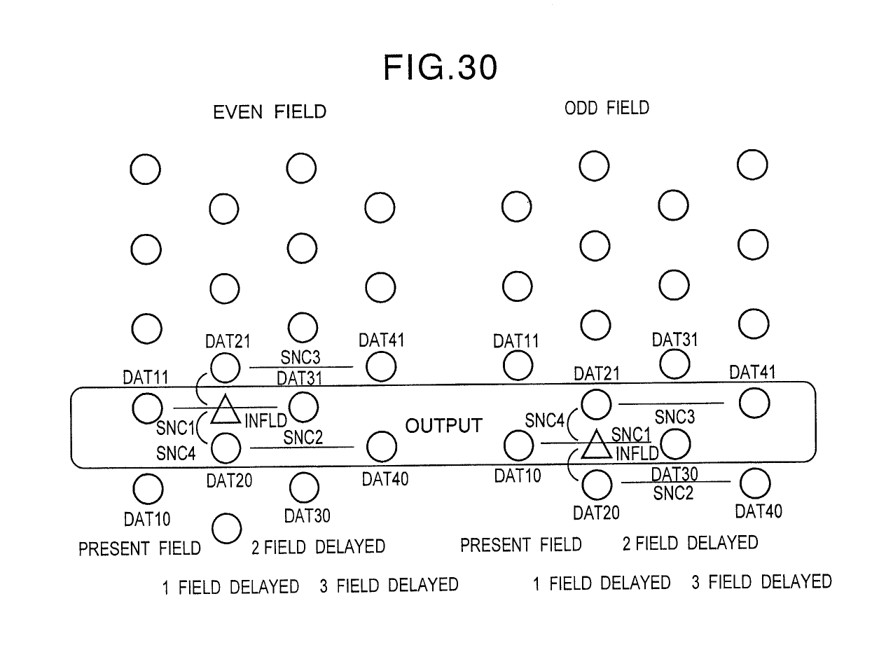

Input data (DAT) is stored in the RAM 212, and data satisfying the relations in FIG. 30 are output.

For even fields, DAT 11, and for odd fields, DAT 10 are output to the SEL block 209 and SNC1 block 203.

DAT 20 and DAT 21 are output to the SEL block 209 and the INFLD block 202.

For even fields, DAT 31, and for odd fields, DAT 30 are output to the SNC1 block 203 and SNC2 block 204.

Further, the output of the SNC1 block 203 is stored in the RAM 212, and data corresponding to SNC2 and SNC3 in FIG. 30 are output to the MAX3 block 206.

Further, the output of the CDEXP block 207 is stored in the RAM 212, and data at the same position in the preceding frame is output to the CDEXP block 207.

INFLD Block 202

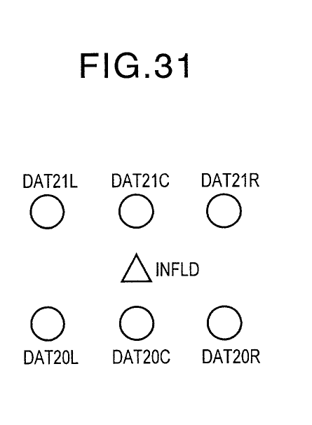

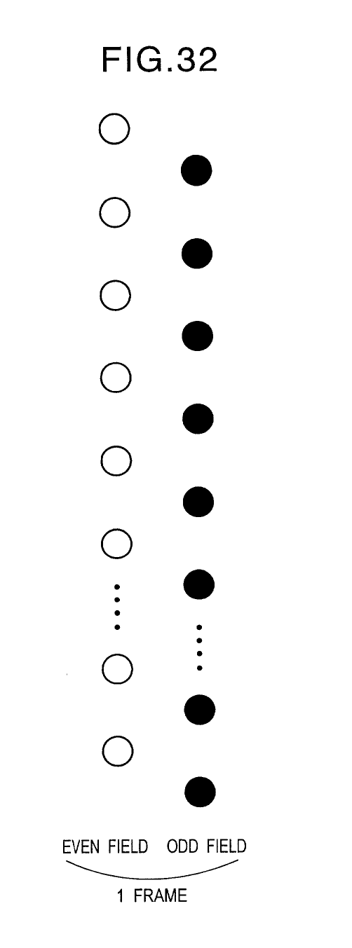

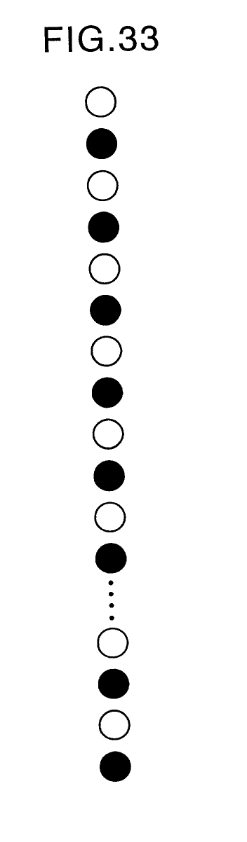

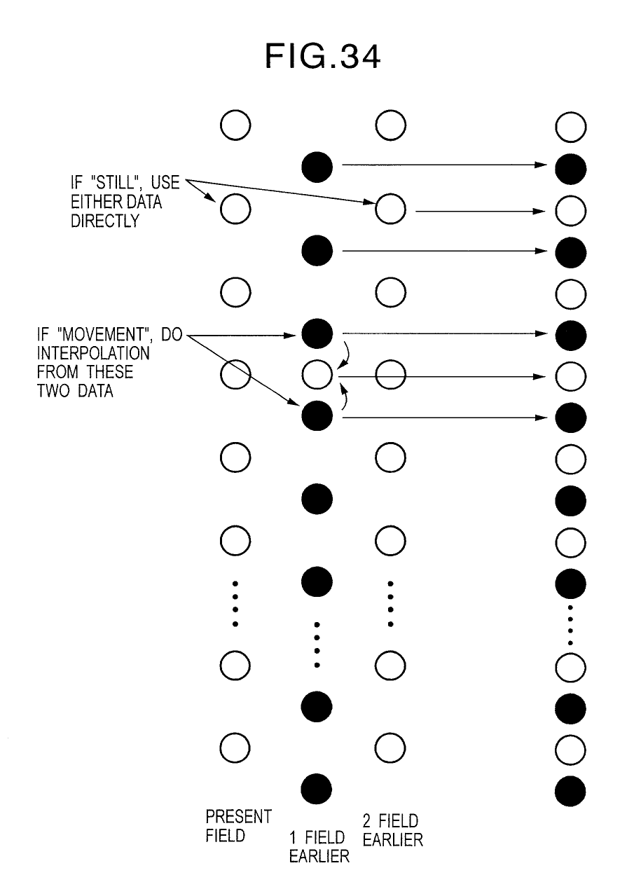

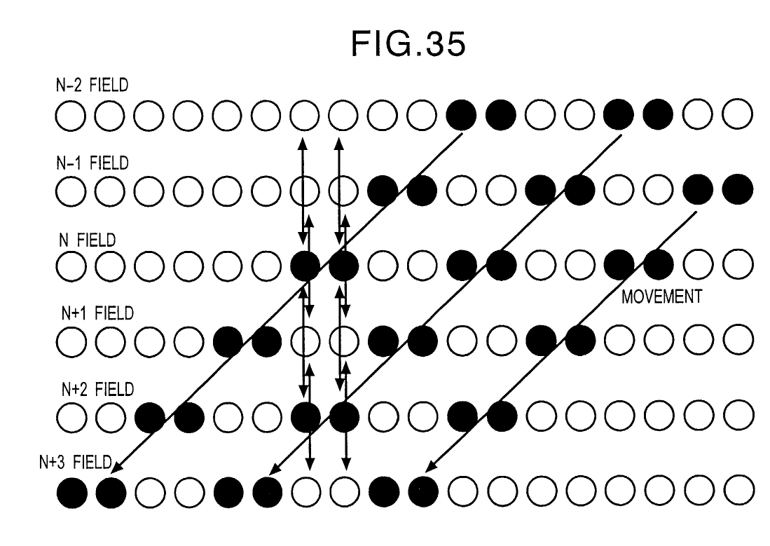

As shown in FIG. 31, data DAT 20 and DAT 21 obtained from the memory controller 201 are stored in the registers and are represented by DAT 20L and DAT 21L, respectively.

Furthermore, data delayed by one clock is stored in the registers and are represented by DAT 20C and DAT 21C.

Furthermore, data delayed by one clock is stored in the registers and are represented by DAT 20R and DAT 21R.

Then, if the absolute value of the difference of DAT 20C and DAT 21C is less than a specific threshold value, the arithmetic average of DAT 20C and DAT 21C is output to the SNC2 block 204 and MIX block 210. Otherwise, DAT 20L, DAT 20C, DAT 20R, DAT 21L, DAT 21C, and DAT 21R are sorted, and the arithmetic average of the two values in the middle are output to the SNC2 block 204 and MIX block 210.

SNC1 Block 203 and SNC2 Block 204

The absolute value of the difference of two input values is calculated, and the result transformed by a function according to that in FIG. 20 is output.

The SNC1 block 203 outputs data to the memory controller 201, MAX2 block 205, and MAX3 block 206, and the SNC2 block 204 to the MAX2 block 205.

MAX2 block 205

The MAX2 block 205 compares an output value of the SNC1 block 203 with an output value of the SNC2 block 204, and outputs the larger value to the MIN block 208.

MAX3 block 206

The output value (SNCA) of the SNC1 block 203 and data (SNCB, SNCC) from the memory controller 201 are input. The MAX3 block 206 compares SNCA with SNCB, and compares SNCA with SNCC. Further, the MAX3 block 206 compares the larger value of SNCA and SNCB with the larger value of SNCA and SNCC, and outputs the smaller value thereof to the CDEXP block 207 and MIN block 208.

CDEXP Block 207

The output data from the MAX3 block 206 is input, and if the value is 8, 4 is output to the memory controller 201.

The output data from the MAX3 block 206 is input, and if the value is less than 8, the output data from the memory controller 201 is input, and its value is subtracted. If the result is less than 0, it is set to 0, and is output to the memory controller 201.

If the output value to the memory controller 201 is 0, 0 is output to the MIN block 208, otherwise, 1 is output to the MIN block 208.

MIN Block 208

The flag from the CDEXP block 207 is input. If the value is 0, the value input from the MAX3 block 206 is output to the MIX block 210. Otherwise, the value input from the MAX2 block 205 is output to the MIX block 210.

SEL Block 209

Field signals and data from the memory controller 201 are input. For even fields, data corresponding to DAT 31 in FIG. 30, and for odd fields, data corresponding to DAT 30 in FIG. 30 is output to the MIX block 210.

For even fields, data corresponding to DAT 20 in FIG. 30, and for odd fields, data corresponding to DAT 21 in FIG. 30 is output to the OUTSEL block 211.

MIX Block 210

The data (R) from the INFLD block 202, data (DAT3) from the SEL block 209, and data (MX) from the MIN block 210 are input, and (MX*R+DAT3*(8−MX))/8 is computed. The result is output to the OUTSEL block 211.

OUTSEL Block 211

The output from the MIX block 210 and output from the SEL block 209 are stored in the memory in units of lines and are output line by line at a double speed.

Even if the processing means according to the present invention is comprised of a combination of the above logic circuits, the accuracy of motion detection at the time of IP conversion can be improved, and IP conversion can be performed at a high accuracy.

Summarizing the effects of the invention, according to the present invention, the accuracy of motion detection at the time of IP conversion can be improved, and IP conversion can be performed at a high accuracy.

While the invention has been described with reference to specific embodiment chosen for purpose of illustration, it should be apparent that numerous modification could be made thereto by those skilled in the art without departing from the basic concept and scope of the invention.

What is claimed is:

1. An image signal processing apparatus for forming interpolation data for lines without interlace signal data by detecting motion and for converting image data from an interlace signal to a progressive signal based on the interpolation data, comprising
a processing means for detecting motion at the time of conversion of image data from an interlace signal to a progressive signal by
using data of a present field, one-field delayed data, two-field delayed data, and three-field delayed data,
deciding a function for expressing a moving quantity by an absolute value of a difference of two of the data,
finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay, and
using the smaller one of the two maximum values found as the moving quantity of the pixel R whose motion is to be detected.

2. An image signal processing apparatus as set forth in claim 1, wherein the processing means uses the data obtained by intra-field interpolation from pixels B and C at lines above and below the pixel R whose motion is to be detected for a place of a large moving quantity and uses the data of the pixel D at the same position after a two-field delay for a place of a small moving quantity.

3. An image signal processing apparatus as set forth in claim 1, wherein the processing means uses the data obtained by intra-field interpolation from pixels B and C at lines above and below the pixel R whose motion is to be detected for a place of a large moving quantity, while uses an average of the data of the pixel A at the same position in the present field and the data of the pixel D at the same position after a two-field delay for a place of a small moving quantity.

4. An image signal processing apparatus as set forth in claim 1, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

5. An image signal processing apparatus as set forth in claim 2, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

6. An image signal processing apparatus as set forth in claim 3, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

7. An image signal processing apparatus as set forth in claim 1, wherein said processing means comprises an SIMD control processor including processor elements arranged in parallel one dimensionally.

8. An image signal processing apparatus as set forth in claim 2, wherein said processing means comprises an SIMD control processor including processor elements arranged in parallel one dimensionally.

9. An image signal processing apparatus as set forth in claim 3, wherein said processing means comprises an SIMD control processor including processor elements arranged in parallel one dimensionally.

10. An image signal processing apparatus as set forth in claim 7, wherein said SIMD control processor including processor elements arranged in parallel one dimensionally is a processor for bit processing.

11. An image signal processing apparatus as set forth in claim 8, wherein said SIMD control processor including processor elements arranged in parallel one dimensionally is a processor for bit processing.

12. An image signal processing apparatus as set forth in claim 9, wherein said SIMD control processor including processor elements arranged in parallel one dimensionally is a processor for bit processing.

13. An image signal processing apparatus as set forth in claim 1, wherein said processing means includes a plurality of logic circuits.

14. An image signal processing apparatus for forming interpolation data for lines without interlace signal data by detecting motion and converting image data from an interlace signal to a progressive signal based on the interpolation data, comprising
a processing means for detecting motion at the time of conversion of image data from an interlace signal to a progressive signal by
using data of a present field, one-field delayed data, two-field delayed data, and three-field delayed data,
deciding a function for expressing a moving quantity by an absolute value of a difference of two of the data,
finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel A at the same position in the present field and a moving quantity of data of the pixel A in the present field at the same position as the pixel R whose motion is to be detected and data of the pixel D at the same position after a two-field delay, and
using the smaller one of the two maximum values as the moving quantity of the pixel R whose motion is to be detected.

15. An image signal processing apparatus as set forth in claim 14, wherein the processing means uses the data obtained by intra-field interpolation from pixels B and C at lines above and below the pixel R whose motion is to be detected for a place of a large moving quantity, while uses the data of the pixel A at the same position in the present field for a place of a small moving quantity.

16. An image signal processing apparatus as set forth in claim 14, wherein the processing means uses the data obtained by intra-field interpolation from pixels B and C at lines above and below the pixel R whose motion is to be detected for a place of a large moving quantity, while uses an average of the data of the pixel A at the same position in the present field and the data of the pixel D at the same position after a two-field delay for a place of a small moving quantity.

17. An image signal processing apparatus as set forth in claim 14, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

18. An image signal processing apparatus as set forth in claim 15, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

19. An image signal processing apparatus as set forth in claim 16, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

20. An image signal processing apparatus as set forth in claim 14, wherein said processing means comprises an SIMD control processor including processor elements arranged in parallel one dimensionally.

21. An image signal processing apparatus as set forth in claim 15, wherein said processing means comprises an SIMD control processor including processor elements arranged in parallel one dimensionally.

22. An image signal processing apparatus as set forth in claim 16, wherein said processing means comprises an SIMD control processor including processor elements arranged in parallel one dimensionally.

23. An image signal processing apparatus as set forth in claim 20, wherein said SIMD control processor including processor elements arranged in parallel one dimensionally is a processor for bit processing.

24. An image signal processing apparatus as set forth in claim 21, wherein said SIMD control processor including processor elements arranged in parallel one dimensionally is a processor for bit processing.

25. An image signal processing apparatus as set forth in claim 22, wherein said SIMD control processor including processor elements arranged in parallel one dimensionally is a processor for bit processing.

26. An image signal processing apparatus as set forth in claim 14, wherein said processing means includes a plurality of logic circuits.

27. An image signal processing apparatus for forming interpolation data for lines without interlace signal data by detecting motion and for converting image data from an interlace signal to a progressive signal based on the interpolation data, comprising:
a first memory for writing and reading of moving quantity obtained by calculation and
a processing means for detecting motion at the time of conversion of image data from an interlace signal to a progressive signal by
using data of a present field and two-field delayed data,
deciding a function for expressing a moving quantity by an absolute value of a difference of two data,
finding a moving quantity of data of a pixel A in the present field at the same position as a pixel R whose motion is to be detected and data of a pixel D at the same position after a two-field delay,
writing this value into the first memory,
reading out from the first memory a moving quantity of data of a pixel B after a one-field delay one line above a pixel R whose motion is to be detected of one field before and data of a pixel E at the same position after a three-field delay and a moving quantity of data of a pixel C after a one-field delay one line below the pixel R whose motion is to be detected and data of a pixel F at the same position after a three-field delay, and
using these moving quantities to detect motion.

28. An image signal processing apparatus as set forth in claim 27, wherein said processing means
finds a first moving quantity of the data of the pixel A in the present field at the same position as the pixel R whose motion is to be detected and the data of the pixel D at the same position after a two-field delay,
writes this moving quantity into the first memory,
reads out from the first memory a second moving quantity of the data of the pixel B after a one-field delay one line above the pixel R whose motion is to be detected of one field before and the data of the pixel E at the same position after a three-field delay, and a third moving quantity of the data of the pixel C after a one-field delay one line below the pixel R whose motion is to be detected and the data of the pixel F at the same position after a three-field delay,
finds a fourth moving quantity that is the maximum value of the first moving quantity and the second moving quantity and a fifth moving quantity that is the maximum value of the first moving quantity and the third moving quantity,
uses the smaller value of the fourth moving quantity and fifth moving quantity as the moving quantity of the pixel,
uses the data obtained by intra-field interpolation from pixels B and C at lines above and below the pixel R whose motion is to be detected for a place of a large moving quantity, and
uses the data of the pixel D at the same position after a two-field delay for a place of a small moving quantity.

29. An image signal processing apparatus as set forth in claim 27,
further comprising a second memory for storing a predetermined screen's worth of values, wherein
the processing means
finds a first moving quantity of the data of the pixel A in the present field at the same position as the pixel R whose motion is to be detected and the data of the pixel D at the same position after a two-field delay,
writes this moving quantity into the first memory,
reads out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay,
finds a fourth moving quantity that is the maximum value of the first moving quantity and second moving quantity and a fifth moving quantity that is the maximum value of the first moving quantity and third moving quantity,
finds a sixth moving quantity that is the smaller value of the fourth moving quantity and fifth moving quantity,
finds an eighth moving quantity that is the maximum value of a seventh moving quantity of data obtained by intra-field interpolation from pixels B and C at lines above and below the pixel R whose motion is to be detected and the data of the pixel D at the same position after a two-field delay and first moving quantity of the data of the pixel A in the present field at the same position as the pixel R whose motion is to be detected and the data of the pixel D at the same position after a two-field delay,
writes a specific initial value to the second memory if the sixth moving quantity is greater than a certain threshold value,
otherwise reduces the data read from the second memory by 1,
writes zero to the second memory if the result is less than 0,
uses the sixth moving quantity as the result of motion detection if the value is zero,
otherwise uses the eighth moving quantity as the result of motion detection,
uses the data obtained by intra-field interpolation from pixels B and C at lines above and below the pixel R whose motion is to be detected for a place of a large moving quantity, and
uses the data of the pixel D at the same position after a two-field delay for a place of a small moving quantity.

30. An image signal processing apparatus as set forth in claim 28, wherein the processing means uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

31. An image signal processing apparatus as set forth in claim 29,wherein the processing means uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

32. An image signal processing apparatus as set forth in claim 27, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

33. An image signal processing apparatus as set forth in claim 28, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

34. An image signal processing apparatus as set forth in claim 29, wherein, when finding intra-field interpolation data, if the absolute value of the difference of the data at immediately upper and lower positions in lines above and below is less than a certain threshold value, said processing means interpolates by using the average value of the data at immediately upper and lower positions in lines above and below, otherwise, said processing means interpolates by using the average value of the data of two central values among a plurality of pixels in the vicinity of the lines above and below.

35. An image signal processing apparatus as set forth in claim 27, wherein said processing means comprises an SIMD control processor including processor elements arranged in parallel one dimensionally.

36. An image signal processing apparatus as set forth in claim 28, wherein said processing means comprises an SIMD control processor including processor elements arranged in parallel one dimensionally.

37. An image signal processing apparatus as set forth in claim 29, wherein said processing means comprises an SIMD control processor including processor elements arranged in parallel one dimensionally.

38. An image signal processing apparatus as set forth in claim 35, wherein said SIMD control processor including processor elements arranged in parallel one dimensionally is a processor for bit processing.

39. An image signal processing apparatus as set forth in claim 36, wherein said SIMD control processor including processor elements arranged in parallel one dimensionally is a processor for bit processing.

40. An image signal processing apparatus as set forth in claim 37, wherein said SIMD control processor including processor elements arranged in parallel one dimensionally is a processor for bit processing.

41. An image signal processing apparatus as set forth in claim 27, wherein said processing means includes a plurality of logic circuits.

42. An image signal processing method for forming interpolation data for lines without interlace signal data by detecting motion and for converting image data from an interlace signal to a progressive signal based on the interpolation data, comprising,
a step of detecting motion at the time of conversion image data from an interlace signal to a progressive signal, comprising the steps of
using data of a present field, one-field delayed data, two-field delayed data, and three-field delayed data,
deciding a function for expressing a moving quantity by an absolute value of a difference of two of the data,
finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel D at the same position after a two-field delay and a moving quantity of the data of the pixel A in the present field at the same position as the pixel R whose motion is to be detected and the data of the pixel D at the same position after a two-field delay, and
using the smaller one of the two maximum values as the moving quantity of the pixel R whose motion is to be detected.

43. An image signal processing method as set forth in claim 42, which uses the data obtained by intra-field interpolation from pixels B and C at lines above and below the pixel R whose motion is to be detected for a place of a large moving quantity and uses the data of the pixel D at the same position after a two-field delay for a place of a small moving quantity.

44. An image signal processing method as set forth in claim 42, which uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

45. An image signal processing method as set forth in claim 42, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

46. An image signal processing method as set forth in claim 43, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

47. An image signal processing method as set forth in claim 44, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

48. An image signal processing method for forming interpolation data for lines without interlace signal data by detecting motion and for converting image data from an interlace signal to a progressive signal based on the interpolation data, comprising,
a step of detecting motion at the time of conversion image data from an interlace signal to a progressive signal, comprising the steps of
using data of a present field, one-field delayed data, two-field delayed data, and three-field delayed data,
deciding a function for expressing a moving quantity by an absolute value of a difference of two of the data,
finding a maximum value of a moving quantity of data of a pixel A in the present field at the same position as a pixel R whose motion is to be detected and data of a pixel D at the same position after a two-field delay, a moving quantity of data of a pixel B after a one-field delay one line above the pixel R whose motion is to be detected and data of a pixel E at the same position after a three-field delay, and a moving quantity of data of a pixel C after a one-field delay one line below the pixel R whose motion is to be detected and data of a pixel F at the same position after a three-field delay and a maximum value of a moving quantity of data obtained by intra-field interpolation from pixels B and C at lines above and below the pixel R whose motion is to be detected and data of the pixel A at the same position in the present field and a moving quantity of data of the pixel A in the present field at the same position as the pixel R whose motion is to be detected and data of the pixel D at the same position after a two-field delay, and
using the smaller one of the two maximum values as the moving quantity of the pixel R whose motion is to be detected.

49. An image signal processing method as set forth in claim 48, which uses the data obtained by intra-field interpolation from pixels B and C at lines above and below the pixel R whose motion is to be detected for a place of a large moving quantity and uses the data of the pixel A at the same position in the present field for a place of a small moving quantity.

50. An image signal processing method as set forth in claim 48, which uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

51. An image signal processing method as set forth in claim 48, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

52. An image signal processing method as set forth in claim 49, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

53. An image signal processing method as set forth in claim 50, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

54. An image signal processing method for forming interpolation data for lines without interlace signal data by detecting motion and for converting image data from an interlace signal to a progressive signal based on the interpolation data, comprising,
a step of detecting motion at the time of conversion image data from an interlace signal to a progressive signal, comprising the steps of
using data of a present field and two-field delayed data,
deciding a function for expressing a moving quantity by an absolute value of a difference of the two data,
finding a moving quantity of data of a pixel A in the present field at the same position as a pixel R whose motion is to be detected and data of a pixel D at the same position after a two-field delay,
writing this value into a first memory,
reading out from the first memory a moving quantity of data of a pixel B after a one-field delay one line above a pixel R whose motion is to be detected of one field before and data of a pixel E at the same position after a three-field delay and a moving quantity of data of a pixel C after a one-field delay one line below the pixel R whose motion is to be detected and data of a pixel F at the same position after a three-field delay, and
using these moving quantities to detect motion.

55. An image signal processing method as set forth in claim 54, further comprising the steps of
finding a first moving quantity of the data of the pixel A in the present field at the same position as the pixel R whose motion is to be detected and the data of the pixel D at the same position after a two-field delay,
writing this moving quantity into the first memory,
reading out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay,
finding a fourth moving quantity that is the maximum value of the first moving quantity and the second moving quantity and a fifth moving quantity that is the maximum value of the first moving quantity and the third moving quantity,
using the smaller value of the fourth moving quantity and fifth moving quantity as the moving quantity of the pixel,
using the data obtained by intra-field interpolation from pixels B and C at lines above and below the pixel R whose motion is to be detected for a place of a large moving quantity, and
using the data of the pixel D at the same position after a two-field delay for a place of a small moving quantity.

56. An image signal processing method as set forth in claim 54, further comprising the steps of
finding a first moving quantity of the data of the pixel A in the present field at the same position as the pixel R whose motion is to be detected and the data of the pixel D at the same position after a two-field delay,
writing this moving quantity into the first memory,
reading out from the first memory a second moving quantity of the data of the pixel B after a one-field delay one line above the pixel R whose motion is to be detected of one field before and the data of the pixel E at the same position after a three-field delay and a third moving quantity of the data of the pixel C after a one-field delay one line below the pixel R whose motion is to be detected and the data of the pixel F at the same position after a three-field delay,
finding a fourth moving quantity that is the maximum value of the first moving quantity and second moving quantity and a fifth moving quantity that is the maximum value of the first moving quantity and third moving quantity,
finding a sixth moving quantity that is the smaller value of the fourth moving quantity and fifth moving quantity,
finding an eighth moving quantity that is the larger value of a seventh moving quantity of data obtained by intra-field interpolation from pixels B and C at lines above and below the pixel R whose motion is to be detected and the data of the pixel D at the same position after a two-field delay and first moving quantity of the data of the pixel A in the present field at the same position as the pixel R whose motion is to be detected and the data of the pixel D at the same position after a two-field delay,
writing a specific initial value to a second memory for storing a predetermined screen's worth of values if the sixth moving quantity is greater than a certain threshold value,
otherwise reducing the data read from the second memory by 1,
writing zero to the second memory if the result is less than 0,
using the sixth moving quantity as the result of motion detection if the value is zero,
otherwise using the eighth moving quantity as the result of motion detection,
using the data obtained by intra-field interpolation from pixels B and C at lines above and below the pixel R whose motion is to be detected for a place of a large moving quantity, and
using the data of the pixel D at the same position after a two-field delay for a place of a small moving quantity.

57. An image signal processing method as set forth in claim 55, which uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

58. An image signal processing method as set forth in claim 56, which uses the data obtained by intra-field interpolation from pixels B and C at lines above and below the pixel R whose motion is to be detected for a place of a large moving quantity and uses an average of the data of the pixel A at the same position in the present field and the data of the pixel D at the same position after a two-field delay for a place of a small moving quantity.

59. An image signal processing method as set forth in claim 54, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

60. An image signal processing method as set forth in claim 55, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.

61. An image signal processing method as set forth in claim 56, which, when finding intra-field interpolation data, if the absolute value of the difference of the data at immediately upper and lower positions in lines above and below is less than a certain threshold value, interpolates by using the average value of the data at immediately upper and lower positions in lines above and below, otherwise, interpolates by using the average value of the data of two central values among a plurality of pixels in the vicinity of the lines above and below.
